(19) United States
(12) Patent Application Publication
(10) Pub. No.: US 2024/0028371 A1
(43) Pub. Date: Jan. 25, 2024

(54) APPLICATION STATE SYNCHRONIZATION ACROSS COMPUTING ENVIRONMENTS

(71) Applicant: Microsoft Technology Licensing, LLC, Redmond, WA (US)

(72) Inventors: Elina LUTHRA, Kirkland, WA (US); Philip J. GERITY, Issaquah, WA (US); Sandeep PATNAIK, Kirkland, WA (US); Randall Richards COOK, Washington, UT (US)

(21) Appl. No.: 17/937,133

(22) Filed: Sep. 30, 2022

Related U.S. Application Data
(60) Provisional application No. 63/390,433, filed on Jul. 19, 2022.

(51) Int. Cl. G06F 9/455; G06F 9/30

(52) U.S. Cl. CPC G06F 9/45558; G06F 9/30087; G06F 2009/4557; G06F 2009/45583

(57) ABSTRACT

Methods, systems, apparatuses, and computer-readable storage mediums are described herein for software application state synchronization across computing environments. A user working in an application at a first state may change computing environments and open the application in a second computing environment at the same state. The first instance of the software application executing on the first computing environment is locked and application specific state information including memory state information scanned from runtime memory or persistent memory, and execution state information from render commands intercepted by an operating system filter, are written to a synchronization file that is stored in the memory system. Application agnostic information is also written to the synchronization file. The file is transmitted to the second computing environment where the application specific and agnostic state information is applied to a second instance of the software application for execution in the second computing environment.

### CROSS-REFERENCE TO RELATED APPLICATION

This application claims the benefit of and claims priority to pending U.S. Provisional Patent Application No. 63/390,433 (Attorney Docket No. 412049-US-PSP) entitled “APPLICATION STATE SYNCHRONIZATION ACROSS COMPUTING ENVIRONMENTS,” which was filed on Jul. 19, 2022, and is related to U.S. patent application Ser. No. ______ (Attorney Docket No. 412049-US-NP[2]) entitled “APPLICATION STATE SYNCHRONIZATION ACROSS COMPUTING ENVIRONMENTS TO AN ALTERNATE APPLICATION,” which was filed on same day herewith, both of which are incorporated by reference herein in their entireties.

### BACKGROUND

The state of a software application, or program state, may comprise everything that keeps an application running at a particular point in time during execution. The application state may include inputs, outputs, and events occurring across multiple related data flows that maintain the progress and form a complete picture of the application at any given moment throughout the execution of the software application.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, apparatuses, and computer-readable storage mediums described herein provide for application state synchronization across computing environments and cross-machine application state recovery. For example, a system is described for synchronizing a state of a first instance of a software application executing on a first computing environment with a second instance of the software application to be executed on a second computing environment. The system comprises the first computing environment having a memory system, that includes a runtime memory and a persistent memory storing program code, and a processing system comprising a processor. The processor receives the program code from the memory system and, in response, locks the first instance of the software application preventing user inputs thereto and generation of a new instance thereof. The processor further scans at least one of the runtime memory or the persistent memory to identify memory state information that is specific to the first instance of the software application. The memory state information is written to a data structure in a synchronization file that is stored in the memory system. The processor intercepts render commands for the first instance of the software application via an operating system level system filter to identify execution state information that is specific to the first instance of the software application. The processor further writes the execution state information to the data structure and transmits the synchronization file to the second computing environment.

Further features and advantages, as well as the structure and operation of various example embodiments, are described in detail below with reference to the accompanying drawings. It is noted that the example implementations are not limited to the specific embodiments described herein. Such example embodiments are presented herein for illustrative purposes only. Additional implementations will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate example embodiments of the present application and, together with the description, further serve to explain the principles of the example embodiments and to enable a person skilled in the pertinent art to make and use the example embodiments.

FIG. 1 shows a block diagram of an example network-based computing system configured for application state synchronization across computing environments, in accordance with an example embodiment.

FIG. 2 shows a block diagram of a system configured for application state synchronization across computing environments, in accordance with an example embodiment.

FIG. 3 shows a block diagram of an example network-based computing system configured for application state synchronization across computing environments, in accordance with an example embodiment.

FIG. 4 shows a flowchart of a method for application state synchronization across computing environments from a first instance of a software application, in accordance with an example embodiment.

FIG. 5 shows a flowchart of a method for verifying and/or synchronizing application information from persistent memory of a first computing environment to a second computing environment for application state synchronization, in accordance with an example embodiment.

FIG. 6 shows a flowchart of a method to remedy a difference in non-persistent network configuration information between a first computing environment and a second computing environment for application state synchronization, in accordance with an example embodiment.

FIG. 7 shows a flowchart of a method for capturing memory state information stored in a hot state in runtime memory and/or in a cold state paged to persistent memory for application state synchronization, in accordance with an example embodiment.

FIG. 8 shows a flowchart of a method for application state synchronization across computing environments to a second instance of a software application, in accordance with an example embodiment.

FIG. 9 depicts a system flow diagram illustrating a sequence of actions that implement application state synchronization across computing environments to a same or an alternate application, in accordance with an example embodiment.

FIG. 10 shows a flowchart of a method for application state synchronization across computing environments to an alternate application, in accordance with an example embodiment.

FIGS. 11-13 each show a flowchart of a method for utilizing a file extension to determine an alternate application for performing application state synchronization across computing environments, in accordance with an example embodiment.

FIG. 14 is a block diagram of an example processor-based computer system that is used to implement various embodiments.

The features and advantages of the implementations described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

Aspects described herein are directed to application state synchronization across computing environments. For example, aspects herein provide for synchronizing application state such as, but not limited to, cursor placement, window position, open documents, commands, execution state, z-order presentation in a user interface, etc., from one computing environment to another. If an end-user is working in an application(s) on a local device and/or virtual machine, in one scenario, and they would like to continue where they left off in a different computing environment, there are no current solutions capable of doing so while still keeping the state of each application that was in use at a given moment.

Aspects disclosed herein provide technical solutions in which a user is enabled to dynamically synchronize and transmit object data, such as a synchronization file having a data structure storing application state information, from one computing environment (a source) to another (a target or destination) via a synchronization service and/or an application, storing the synchronization object, retrieving the synchronization object, and applying the synchronization object data of any given application state.

### II. Example Implementations

Files, applications, or user profiles may be transferred in a conventional synchronization process, but these types of synchronization lack the ability to synchronize an application state across multiple computing devices. That is, current solutions do not provide the ability to execute an application at a target device, to open a particular file and recreate the application state from the source device as it was presented to a user at the time of transfer and synchronization. Additionally, existing solutions are not capable of moving or opening applications bi-directionally between a cloud-based computing environment and a local device with an application state saved, using “move to” functionality, nor are there solutions to open a file in an alternate application if the default application is not used or available. Further, migration of virtual machines requires copying and transmitting an entire virtual machine, which requires large amounts of data to be copied, and specific target systems capable of executing the virtual machine.

Example aspects of application state synchronization across computing environments include operations for source computing environments, cloud-based or host-based environments, and target (i.e., destination) computing environments. For instance, in source computing environments, the state synchronization object data is captured. In some aspects, the capture is initiated by an automated or manual trigger function, and a state manager receives a call to capture the state of the software application(s) execution. Optionally, the state manager stores the state synchronization object data locally and/or at the cloud-environment or host-environment. The trigger function is performed by a local device, a cloud-device, a host-device, or another device or service associated with management of computing environments described herein. In target computing environments, the state synchronization object data is applied. This is initiated, in the target, by an automated or manual trigger, and a state manager (e.g., executing in the background) receives a call to query for the state synchronization object, then retrieve it. The state manager determines if the software application(s) which the end-user would like to open for synchronization exist in the computing environment (target). If so, then the software application state(s) data is applied to the software application in the target computing environment. Alternatively or in addition, a determination is made as to whether an alternate software application(s) should be used. If an alternate software application is automatically-selected or user-selected for use, a portion or a subset of the application(s) state information is applied to the respective alternate software application(s). If it is not selected or available, a matching software application(s) may be downloaded and/or installed, in aspects, and a subset of the application state(s) are applied in the target computing environment to the alternate software application.

Computing environments include, without limitation, local or on-premise personal computing devices (“PCs”) or servers, containers such as secure containers, cloud-based PCs, and/or the like. An example container may include a package of software that bundles a software application's code together with related configuration files and libraries, and with the dependencies utilized for executing the software application. A cloud-based PC may comprise a cloud-based virtual machine that provides an end user at a client device with a desktop experience. Application state synchronization across computing environments is enabled herein for any type of source computing environment to any type of target computing environment. Similarly, exact application state synchronization is enabled between two operating systems of the same kind, such as Windows® to Windows®, or Android™ to Android™ (including different versions thereof), and exact or equivalent application state synchronization is enabled between two different operating systems, such as Windows® to Android™, via alternate applications at the target computing environment. Further exemplary details regarding this application state synchronization across computing environments are provided below.

The state of an application in various aspects includes, but is not limited to, cursor placement (e.g., mouse and/or keyboard), associated user identity(ies), user interface positions and/or z-orders, active or in-focus status, current menu(s), tabs, sub-windows, files open, saved or not saved status, mode (e.g., read only, edit), and/or the like.

By way of example, scenarios illustrating the technical benefits of the described aspects for application state synchronization across computing environments are provided below.

In one scenario, a user “Tom” is working from an airport using a cloud-based PC and loses his internet connection. He is prompted with a pop-up message that asks him if he would like to continue working offline and if yes, or if an automatic trigger is utilized, he is able to see all the applications, in their current application states, and files he was using in his cloud-based PC on his local device. That is, his email application, his presentation slides program, and his browser tabs are all provided on this local device, instead of the cloud-based PC, and Tom is enabled to continue working from where he left off.

In another scenario, a user “Cindy” is working on an architecture blueprint on a computer graphics program from her local PC. She notices that the application she is using is not performing efficiently, so she clicks on a button on top of the application that states ‘Launch in Cloud-Based PC’ and is prompted to login to her cloud-based PC where the application downloads and opens the saved changes. Cindy is enabled to continue to work from her higher-end cloud-based PC device without any productivity loss because the state of her application will be presented on the cloud-based PC in the same state as when she left off at her local PC.

In another scenario, Tom has four hardware devices and one cloud-based PC. Everyone in his family owns a hardware device. During the weekdays he chooses to synchronize his cloud-based PC to the hardware device he uses for work, being able to easily continue where he left off (with his emails, documents, etc.). In the evenings and weekends, Tom gives his family the option to use the high-end cloud-based PC by enabling them to synchronize their own hardware device to the cloud-based PC. For example, his son can continue working on his school project in a document, exactly where the son left off the day before.

In another scenario, Cindy wants to use her printer that is only set up on her new cloud-based PC device. Currently working on her local PC, she is enabled to seamlessly synchronize all of her applications and their respective application states, to her cloud-based PC device and continue editing and print her documents.

In another scenario, Cindy has a low-end local PC that she is using for school. Her device is not usable for her architecture class; however, she is enabled to synchronize her device to a new high end spec cloud-based PC and be more productive instantly at any given time by seamlessly continuing her work without any productivity loss.

In another scenario, Tom has a device running a first version of an operating system that he uses for work and would like to quickly and easily synchronize his profile, applications and respective application states, and PC settings to his new device running a second version of the operating system, and continue working from where he left off. The state of his applications will be present on his new device exactly where he left off from his old device.

In another scenario, a user “Stephanie” is a financial analyst with a financial services provider. On her local PC, which is managed by her company, she is drafting a presentation for her team's business plan for the next quarter. On her cloud-based PC, she has been running some confidential data through a hosted analytics application and now needs to cross reference that data with her locally running application group. She is enabled to quickly open her application group in her cloud-based PC and pull the confidential data into her presentation in a specific table. The application state of each application will be exactly the same in her cloud-based PC desktop as it was in her local device.

In another scenario, Stephanie wants to continue to work on a couple of files she has open in her cloud-based PC during lunch and will not have internet connectivity at the restaurant. She wants to have her document open and a presentation slide deck open to look through and make edits. She can choose to open those applications in her local PC and continue exactly where she left off (e.g., cursor location and all the application state settings being present on the local PC). When she gets to her desktop on her local PC, the two applications will be there exactly where she left off on the cloud-based PC.

In Business Continuity & Disaster Recovery (BCDR) situations, the aspects herein are also applicable for cross-machine application state recovery and provide technical solutions for existing issues.

Accordingly, the aspects herein provide for technical solutions to issues associated with software application usage across computing environments and software application state recovery. For example, embodiments described herein: (1) capture real-time state information of an application to be synchronized for presenting the synchronized application in another computer environment exactly as the user left off; (2) transfer only specific application information between the computing environments, thereby enabling the transfer of less information than, e.g., a virtual machine transfer which requires transfer of the entire virtual machine state, and thus conserving processing, memory and network resources; (3) present the synchronized application in another computing environment exactly as the user left off even when the application is not present/registered at the target computing environment; and (4) provide for the transfer and presentation of source application data in a different application at the computing environment. These and other aspects for software application state synchronization across computing environments will be described in further detail herein in association with the Figures, and in the Sections and Subsections of description that follow below.

For example, FIG. 1 shows a block diagram of an example network-based computing system 100 configured for application state synchronization across computing environments, according to an example embodiment. As shown in FIG. 1, system 100 includes a computing device 102 and a computing device 104. In embodiments, computing device 102 and computing device 104 communicate with each other over a network 112. It should be noted that in various embodiments different numbers of user devices, and/or subcomponents thereof, are present. Additionally, according to embodiments, any combination of the systems and/or components illustrated in FIG. 1 are present in system 100.

Network 112 comprises different numbers and/or types of communication links that connect devices, platforms, and hosts or servers such as, but not limited to, the Internet, wired or wireless networks and portions thereof, point-to-point connections, local area networks, enterprise networks, cloud networks, and/or the like, in embodiments.

Computing device 102 and/or computing device 104 in different embodiments are any number, type, or combination of computing devices or computing systems, including a terminal, a personal computer, a laptop computer, a tablet device, a container executing on any type of computing device, a cloud-based PC, a smart phone, a personal digital assistant, a server(s), a gaming console, and/or the like, including internal/external storage devices, that are utilized to execute functions or operations described herein for executing software applications and for application state synchronization across computing environments. In aspects, computing device 102 and/or computing device 104 also includes additional components (not shown for brevity and illustrative clarity) including, but not limited to, components and subcomponents of other devices and/or systems herein, in embodiments. Computing device 102 and/or computing device 104 may each be referred to as a computing system or a computing environment.

In some embodiments, computing device 102 and/or computing device 104 comprise a state manager 106, as illustrated, that is configured to perform application state synchronization across computing environments, as described herein. For instance, state manager 106 is configured to capture an application state of a software application that is executing at computing device 102, e.g., as a synchronization file or object, and transmit the application state file or object to computing device 104 via network 112. Computing device 102 may be referred to as a first computing environment or source, and computing device 104 may be referred to as a second computing environment, a target, or a destination. Captured application states are stored locally at the source, at the destination, and/or in a network-based or cloud-based platform during this operation. At computing device 104, state manager 106 is configured to apply the application state to the same application executing thereon. In some embodiments, a portion of the application state information is applied to an alternative software application at the target computing device 104. Aspects also include configurations where one or more components of state manager 106 are present in a network-based or cloud-based platform, such as Azure® from Microsoft Corp. of Redmond, WA, or Amazon Web Services' from Amazon Technologies, Inc. of Seattle, WA.

As noted above, computing device 102 and/or computing device 104, as well as network 112, comprise a “cloud-based” platform, in embodiments. These components in some aspects are a network, or “cloud,” implementation for hosted applications and/or services associated with a network architecture and/or cloud platform. A cloud platform includes a networked set of computing resources, including servers, routers, etc., that are configurable, shareable, provide data security, and are accessible over a network such as the Internet, according to embodiments. Cloud applications and/or services for hosting databases and/or data warehousing are configured to run on these computing resources, often atop operating systems that run on the resources, for entities that access the applications and/or services, locally and/or over the network. A cloud platform is configured to support multi-tenancy, where cloud platform-based software services multiple tenants, with each tenant including one or more users who share common access to certain software services and applications of the cloud platform. Furthermore, a cloud platform is configured to support hypervisors implemented as hardware, software, and/or firmware that run virtual machines (emulated computer systems, including operating systems) for tenants. A hypervisor presents a virtual operating platform for tenants. A cloud-based PC, as described herein for some embodiments, executes in a virtual machine that serves as its computing environment.

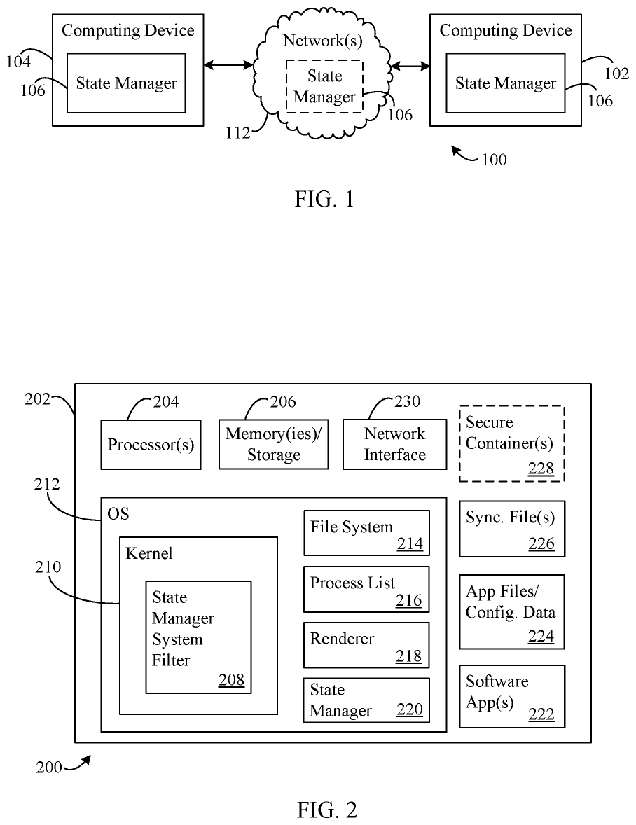

FIG. 2 shows a block diagram of an example system 200 for application state synchronization across computing environments, according to an example embodiment. System 200 as exemplarily illustrated and described is configured to be an embodiment of computing device 102, computing device 104, and/or a portion of network 112, as shown in system 100 in FIG. 1. That is, system 200 is illustrated as being configured to perform operations for application state synchronization across computing environments described herein. System 200 is described as follows.

System 200 includes a computing system 202 which is any type of computing device or computing system, as mentioned elsewhere herein, or as otherwise known, including without limitation cloud-based systems, on-premises systems, distributed network architectures, servers, and/or the like, including portions thereof. As shown in FIG. 2, computing system 202 includes one or more processors (“processor”) 204, one or more of a memory and/or other physical storage device (“memory” or “memory system”) 206, as well as one or more network interfaces (“network interface”) 230. Computing system 202 also includes an operating system (“OS”) 212, a software application(s) 222, application file(s) and/or configuration data 224, and synchronization file(s) 226. Optionally, computing system 202 includes and/or executes one or more secure container(s) 228, which are secure containers configured to execute applications and/or services, in aspects. Computing system 202 may be referred to as a computing device or a computing environment.

Processor 204 and memory 206 are respectively any type of processor circuit(s) and/or system(s) and memory that is described herein, and/or as would be understood by a person of skill in the relevant art(s) having the benefit of this disclosure, in various aspects. An example processor 204 comprises a central processing unit (CPU) or a graphics processing unit (GPU). However, the disclosure is not limited in this regard. Processor 204 and memory 206 each respectively comprise one or more processors or memories, different types of processors or memories (e.g., a cache(s), temporary memory for application execution and/or processing), remote processors or memories, and/or distributed processors or memories. Processor 204 includes multi-core processors configured to execute more than one processing thread concurrently, in aspects, and processor 204 comprises circuitry that is configured to execute computer program instructions such as, but not limited to, embodiments of OS 212, software application(s) 222, and/or secure container(s) 230, including one or more of the components thereof as described herein, when such aspects are implemented as computer program instructions to perform functions and operations for application state synchronization across computing environments, as described herein.

Memory 206 includes volatile storage portions such as a random access memory (RAM) and/or persistent storage portions such as hard drives, non-volatile RAM, caches, solid state drives, and/or the like, to store or be configured to store computer program instructions or code for application state synchronization across computing environments as described herein, as well as to store other information and data described in this disclosure including, without limitation, application files and/or configuration data 224, software application state data in synchronization file(s) 226, and/or the like, in different embodiments. In embodiments, a storage external to computing system 202 comprises a portion of memory 206, and is available for sharing or use by computing system 202 and/or other systems via a network or storage interface.

Network interface 230, in embodiments, is any type or number of wired and/or wireless network adapter, modem, etc., configured to enable system 200, including computing system 202, to communicate intra-system with components thereof, as well as with other devices and/or systems over a network, such as communications between computing system 202 and other devices, systems, hosts, computing environments, etc., of system 100 in FIG. 1, over a network such as network 112.

System 200 also includes additional components (not shown for brevity and illustrative clarity) including, but not limited to, components and subcomponents of other devices and/or systems herein, as well as those described below with respect to FIG. 14, according to embodiments.

OS 212 is any type of operating system in aspects and is configured to be executed by computing system 202. OS 212 examples include, without limitation, any version of Microsoft® Windows® from Microsoft Corporation of Redmond, WA, macOS® from Apple, Inc. of Cupertino, CA, mobile device versions thereof, or any other operating system, including Android™, LINUX® and other UNIX® variants, etc., by way of example. Aspects provide for a state manager system filter (“system filter”) 208 that comprises a portion of a state manager 220 (e.g., an embodiment of state manager 106 in FIG. 1) and that is a kernel-level filter and comprises a filter driver equivalent and/or the like in a kernel 210 of OS 212 that communicates with OS components for calling filtering functions thereof. While embodiments herein are be described and/or illustrated with respect to a particular OS, it should be understood that similar and/or equivalent implementations of aspects herein for different OSs are contemplated under the same described techniques for application state synchronization across computing environments. That is, exemplary descriptions herein are non-limiting and serve to illustrate aspects of application state synchronization across computing environments and implementations without limitation.

OS 212 includes file system 214, which is a file system configured to manage the formatting and persistent storage of data, information, and files in memory 206 of computing system 202, process list 216, which is a list stored in memory 206 that includes the processes currently running on processor 204, as well as information associated with such processes (e.g., process identifiers, execution paths), and a renderer 218 configured to generate render commands causing user interfaces (UIs) and elements thereof for executing ones of software application(s) 222 to be presented in different states according to the operation of software application(s) 222. OS 212 is also illustrated as including state manager 220, as noted above, which is configured to perform one or more functions or operations, e.g., in the background, for application state synchronization across computing environments, as described herein.

As noted above, OS 212 further includes kernel 210 that operates in a kernel space of OS 212, as would be understood by a person of skill in the relevant art(s). Kernel 210 includes system filter 208. System filter 208 is a network-aware, OS-level driver or filter, in embodiments. While shown for illustrative clarity and brevity as being within kernel 210, aspects provide for system filter 208 to also comprise components thereof that reside outside of the kernel space in the user space of OS 212, or a combination of kernel space and user space components. For instance, OS 212 includes state manager 220 comprising a user-space component configured to perform functions and operations, which include those of file system filter 208 in some aspects, including API calls for information and/or operations, as well as for intercepting render commands by system filter 208, as described herein.

During execution of software application(s) 222, render commands are issued by renderer 218 via OS 212, and system filter 208 is configured to intercept or capture these commands and store them in memory 206 as representations for an execution state of software application(s) 222. This interception or capture by system filter 208 is performed for each render command, yet only render commands that cause changes are stored in aspects to improve efficiency and memory usage. Further details regarding system filter 208 are provided herein.

Application files and/or configuration data 224 includes, without limitation, at least one of files generated or utilized by one or more of software application(s) 222 (e.g., a file comprising a text document or a slide presentation document), installation and/or configuration files such as temp files, registry configurations, license files, etc. In aspects, application files and/or configuration data 224 includes user identity information such as credentials, tokens, profiles, user configuration settings, etc.

The software application state data in synchronization file(s) 226 may include a data structure having, without limitation, any of a software application identifier, a memory state information specific to a software application that is scanned from a runtime memory or a persistent memory of memory 206 by state manager 220, execution state information specific to the software application identified from render commands for the software application via system filter 208, software application agnostic information, portions of application files, configuration data 224, and/or the like.

State manager 220 is configured to perform functions and/or operations described herein for application state synchronization across computing environments, according to example embodiments. For instance, in scenarios for which computing system 202 is a source computing environment for application state synchronization across computing environments, state manager 220 (including system filter 208) is configured to lock the software application, gather software application state information, generate synchronization file(s) 226, and provide generated synchronization file(s) 226 to another computing environment (e.g., as from computing device 102 in FIG. 1 to computing device 104, or to cloud-based implementations of network 112 executing containers or cloud-based PCs), as described herein. In scenarios for which computing system 202 is a target computing environment for application state synchronization across computing environments, state manager 220 is configured to utilize a received synchronization file of a software application including the memory state information and execution state information specific to the software application from a source computing environment and write the memory state information to the runtime memory and/or the persistent memory at locations having a first memory pointer, to cause the software application, or an alternate application, to execute updating, at an operating system level, a second memory pointer associated with executing the software application to the first memory pointer. Thus, the software application can be synchronized to the execution state information by altering at least one user interface element associated with the software application at the target computing environment, as described herein.

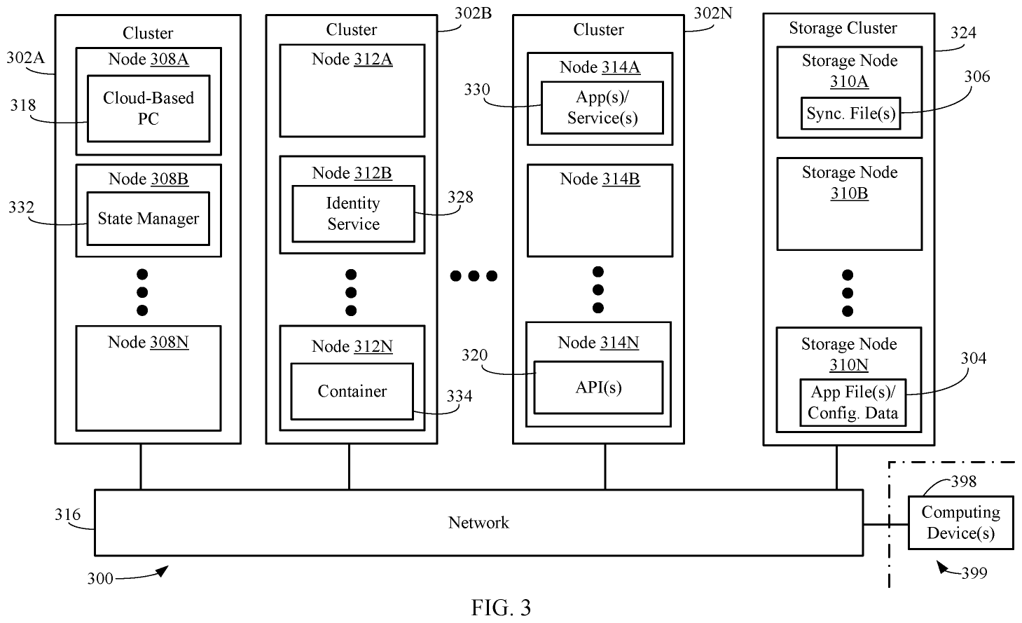

FIG. 3 shows a block diagram of an example network-based computing system 300 configured for application state synchronization across computing environments, according to an example embodiment. As shown in FIG. 3, system 300 includes a plurality of clusters 302A, 302B, and 302N and a storage cluster 324. Each of clusters 302A, 302B, and 302N, and storage cluster 324, are communicatively coupled to each other via network 316. Network 316 comprises one or more networks such as, but without limitation, a cloud network, a local area networks (LANs), wide area networks (WANs), enterprise networks, the Internet, etc., and includes one or more of wired and/or wireless portions, in embodiments. Network 316 may comprise all or a portion of network 112.

In the illustrated embodiment, clusters 302A, 302B, and 302N and/or storage cluster 324 form a network-accessible server set (e.g., a distributed or cloud-based environment or services platform (e.g., an environment or platform hosting types of resources, services, and/or applications)). Each of clusters 302A, 302B, and 302N as illustrated comprise a group of one or more nodes (also referred to as compute nodes) and/or a group of one or more storage nodes. For example, as shown in FIG. 3, cluster 302A includes nodes 308A-308N, cluster 302B includes nodes 312A-312N, and cluster 302N includes nodes 314A-314N. Each of nodes 308A-308N, nodes 312A-312N, and/or nodes 314A-314N are accessible via network 316 (e.g., in a cloud-based embodiment) to build, deploy, and manage applications and services and tenancies. Storage cluster 324 comprises one or more storage nodes 310A-310N. Each of storage node(s) 310A-310N comprises a plurality of physical storage disks or drives, which are configured as secure storage, and that are accessible via network 316 and are configured to store data associated with the applications and services, and/or the like, managed by one or more of nodes 308A-308N, nodes 312A-312N, and/or nodes 314A-314N.

As noted above, system 300 includes one or more distributed or cloud-based servers, in embodiments. That is, system 300 is a network, or cloud, implementation for applications and/or services, which are associated with hosting databases, data warehousing, websites including web stores, productivity applications, analytics, state managers for application state synchronization across computing environments, cloud-based PCs, and/or the like, in a network architecture and/or cloud platform, in various aspects. A cloud platform includes a networked set of computing resources, including servers, routers, etc., that are configurable, shareable, provide data security, and are accessible over a network such as the Internet, according to embodiments. The cloud applications and/or services 330 are configured to run on these computing resources, often atop operating systems that run on the resources, for entities that access the applications and/or services, locally and/or over the network.

In embodiments, one or more of cluster 302A, cluster 302B, and cluster 302N, and/or storage cluster 324, are co-located (e.g., housed in one or more nearby buildings with associated components such as backup power supplies, redundant data communications, environmental controls) to form various computing platforms, or are arranged in other manners. Accordingly, in an embodiment, one or more of cluster 302A, cluster 302B, and cluster 302N, and/or storage cluster 324, are a computing platform or system in a distributed collection of computing platforms and/or systems.

Each of node(s) 308A-308N, node(s) 312A-312N, and node(s) 314A-314N comprise one or more server computers, server systems, and/or computing devices, in embodiments. Each of node(s) 308A-308N, node(s) 312A-312N, and node(s) 314A-314N are configured to execute one or more software applications (or “applications”) and/or services and/or manage hardware resources (e.g., processors, memory, network adapters), which are utilized by users or client entities (e.g., customer or tenant users in cloud-based platforms) of the network-accessible server set. Node(s) 308A-308N, node(s) 312A-312N, and node(s) 314A-314N are also configured in aspects for specific uses. For example, as shown in FIG. 3, node 308A is configured to execute a cloud-based PC 318, node 308B is configured to execute a state manager 332 (e.g., an embodiment of state managers described above in FIGS. 1 and 2), node 312B is configured to execute an identity service 328, node 312N is configured to execute a secure container 334, node 314A is configured to execute other applications and/or services 330, and node 314N is configured to execute one or more APIs 320. It is noted that instances of servicing application 332, identity service 328, other applications and/or services 330, and/or tenancy 320 are executable on other node(s) (e.g., node(s) 308B-308N, node(s) 312A-312N, and/or node(s) 314A-314N) in lieu of or in addition to the nodes respectively noted above. It is further noted that one or more of these components are incorporated with each other in various aspects.

Identity service 328 is configured to maintain a plurality of user identities that associated users utilize to access one or more tenancies, devices, applications, and/or services maintained by system 300 (e.g., tenancies, cloud-based PCs such as cloud-based PC 318, state managers such as state manager 332, web application, and/or services hosted and/or executed by any of node(s) 308A-308N, node(s) 312A-312N, and/or node(s) 314A-314N) and/or associated with identity service 328.

Other applications and/or services 330 include one or more applications, services, etc., that are hosted by system 300, and that have instances thereof executed, or executable, by a compute node. Non-limiting examples of other applications and/or services 330 include, without limitation, productivity applications, policy enforcement applications, analytics services, database or data warehousing services and/or applications, web hosting applications and/or services including for web stores, etc.

Cloud-based PC 318, in aspects, is configured as a portion of one or more virtual machines, as described herein, that comprise a computing environment. A user of cloud-based PC 318 is enabled by aspects herein to authenticate thereto, e.g., via a secure portal executing at a compute node (e.g., a secure portal by which users or tenants of the host provider associated with system 300, are enabled by restricted access to authenticate via identity service 328). Likewise, authentication via identity service 328 enables users or tenants access to state manager 332, other applications and/or services 330 hosted by system 300, and/or the like.

Synchronization file(s) 306 may be an embodiment of synchronization file(s) 226 shown in FIG. 2, is stored in a storage node, as exemplarily shown for storage node 310A, or elsewhere in different embodiments, and corresponds to applications or services executing in a computing environment of system 300 for which application state synchronization across computing environments is to be performed. Application files and/or configuration data 304 is an embodiment of application files and/or application configuration data 224 shown in FIG. 2, is stored in a storage node, as exemplarily shown for storage node 110A, or elsewhere in different embodiments, and corresponds to applications or services executing in a computing environment of system 300 for which application state synchronization across computing environments is to be performed. In embodiments where cloud-based storage is utilized, synchronization file(s) 306 and/or application files and/or configuration data 304 correspond to a software application(s) of a source computing environment that is being transmitted to a target computing environment.

Also shown in FIG. 3 is an external environment 399 in which one more computing devices 398 that are external to system 300 connect to system 300, e.g., via the Internet and network 316. In aspects, one or more computing devices 398 include any number of computing and/or mobile devices and/or systems (e.g., computing environments) that are utilized by client entities and members of the host provider associated with system 300. One or more computing devices 398 in various embodiments includes any number, type, or combination of other computing devices and/or computing systems, including but without limitation, a terminal, a personal computer, a laptop computer, a tablet device, a smart phone, a personal digital assistant, a server(s), a cloud-based PC, a gaming console, and/or the like, including devices in FIG. 1 and computing system 202 in FIG. 2, that include internal/external storage devices in aspects, that are utilized to access cloud-based PCs, services, and/or applications, and/or to otherwise upload and/or download any type of information, data, files, programs, and/or the like, to/from system 300. In some aspects, a device of one or more computing devices 398 is utilized by a user and/or a tenant as a source or target computing environment for application state synchronization across computing environments described herein.

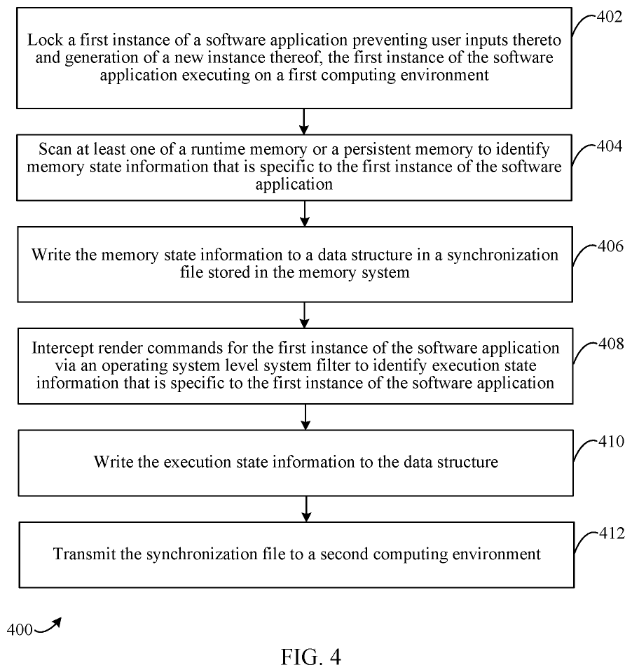

Referring now to FIG. 4, a flowchart 400 is shown for application state synchronization across computing environments from a first instance of a software application, in accordance with an example embodiment. In various aspects, flowchart 400 is implemented by systems shown in FIGS. 1-3, although the method is not limited to those implementations. For illustrative purposes, flowchart 400 will be exemplarily described with continued reference to FIGS. 1-3 from a source perspective where computing system 202 is the source computing environment (“first computing environment”) and cloud-based PC 318 (and associated nodes and clusters of system 300) is the target computing environment (“second computing environment” or “destination”). It should be noted, however, that embodiments of state synchronization between computing environments described herein contemplate intra-device and intra-system transfers and synchronizations such as, but not limited to, between cloud-based PCs executed by system 300 (such as cloud-based PC 318), between secure containers 228 executed by computing system 202 (or between secure container 334 and another secure container executed by system 300), between processor 204 and/or memory 206 and one of secure container(s) 228, etc. Embodiments herein also contemplate transfers (“transmissions”) and synchronizations between cloud-based PCs presented at a computing device (the source) and the computing device itself (the target), or vice versa. State manager 220 is configured, in aspects, to have an instance thereof executing in a secure container and/or to require a target computing environment to be a secure container when the source computing environment is a secure container in order to match security and/or confidentiality for the application state synchronization. In other words, application state synchronization from a first computing environment (“source”) to a second computing environment (destination or “target”) may occur in any permutation of the following sources and destinations: from any of a local computing device, a cloud based PC, or a container, to any of a local computing device, a cloud based PC, or a container.

Other structural and operational embodiments will be apparent to persons skilled in the relevant art(s) based on the discussion regarding flowchart 400 and the systems of FIGS. 1-3.

Flowchart 400 begins with step 402. In step 402, a first instance of a software application is locked preventing user inputs thereto and generation of a new instance thereof. The first instance of the software application executes on a first computing environment. Locking the first instance of the software application, in aspects, is performed responsive to a manual or automatic trigger to begin an application state synchronization across computing environments for the first instance of the software application, e.g., from computing system 202 of system 200 (source) in FIG. 2 to cloud-based PC 318 of system 300 (destination) in FIG. 3 (or, e.g., from computing device 102 to computing device 104 of FIG. 1). In one example, the trigger to begin an application state synchronization across computing environments may comprise receiving a manual or automatic “application move” command at state manager 220 of first computing system 202. However, the disclosure is not limited in this regard and any suitable trigger may be utilized to initiate application state synchronization (e.g., the trigger may occur in the first computing environment, the second computing environment, or elsewhere). The software application executing in the first computing environment (e.g., computing system 202 for illustrative purposes) may be referred to as the first application, the first instance of the application, or the source application, and for illustrative purposes, may comprise software application(s) 222.

A software application(s) 222, executed by processor 204, is locked by state manager 220 of computing system 202 shown in FIG. 2. In this regard, in response to the trigger, state manager 220 disables further user inputs to the first instance of the application and disables creation of a new instance of the software application in the first computing environment. In some embodiments, in conjunction with locking the first instance of the software application, state manager 220 may cause a screen to be displayed to a user that indicates that the application state synchronization is in progress.

Responsive to the locking of the first instance of a software application, state manager 220 may wait until currently executing commands (e.g., compute commands, file saves) are completed and/or until the first instance of the software application is idle (e.g., where no memory or disk writes occur). In some embodiments, commands received by a processor of processor(s) 204 (e.g., by a GPU or CPU) after the currently executing commands have completed, are ignored in first computing system 202

In step 404, at least one of a runtime memory or a persistent memory is scanned to identify memory state information that is specific to the first instance of the software application. For instance, state manager 220 is configured to scan a runtime memory or a persistent memory of memory 206 to identify specific memory state information of the locked first instance of one of the software application(s) 222.

In step 406, the memory state information is written to a data structure in a synchronization file stored in the memory system. For example, state manager 220 is configured to write the memory state information scanned and identified in step 404 to one of synchronization file(s) 226, e.g., into a data structure therein.

In step 408, render commands for the first instance of the software application are intercepted via an operating system level system filter to identify execution state information that is specific to the first instance of the software application. For instance, system filter 208 in state manager 220 of OS 212 is configured to intercept render commands from renderer 218 at the level of OS 212. One or more of the intercepted commands are utilized by system filter 208 and/or state manager 220 to identify the execution state of the first instance of the software application, as described herein. In some embodiments, interception of the render commands is performed continuously and/or in real-time or near-real-time during execution of the first instance of the software application in order to maintain an up-to-date execution state of the first instance of the software application. As described herein, not all render commands are utilized to determine the execution state information that is identified by system filter 208.

In one embodiment, system filter 208 may identify one or more execution state details such as: active window and/or sub-window handles, open menus, tabs, toolbars, ribbons, a current page, mouse and/or keyboard selections, etc. System filter 208 may capture render-commands that are sent to a window manager (e.g., Microsoft Windows shell or a graphical user interface for an operating system) or to a platform application software development kit (e.g., Win32 SDK) from inputs such as a mouse, touch screen, keyboard shortcuts, pen, or other inputs. System filter 208 may discard any input that results in traditional file operations (e.g., typing, coloring, pen input) because saved file changes may be captured or synchronized in “file” copies (see below), and unsaved file changes are captured or synchronized in memory state copies (see below). A software development kit may include a collection of software development tools in an installable package that facilitates the creation of applications. The development kit may have a compiler, debugger, and/or a software framework, and may be specific to a hardware platform and operating system combination.

In step 410, the execution state information is written to the data structure. For example, system filter 208 and/or state manager 220 are configured to write the identified execution state information of step 408 to the data structure of synchronization file(s) 226. Various modifications (or optimizations) may be implemented to improve storage usage, synchronization speed, and user experience of software application execution state synchronization. For example, render-commands that cancel each other are discarded (e.g., clicking-out of a menu dismisses the menu so that render commands for clicking-in and clicking-out of the menu are discarded). Only the most recent sequence of render-commands that are chained together are stored (e.g., clicks on a menu, then a sub-menu, and then a sub-sub-menu would be stored for synchronization). Moreover, the render commands may be saved in synchronization file(s) 226, for example, in local memory storage 206 or in the cloud.

In step 412, the synchronization file is transmitted to a second computing environment. For instance, in the current exemplary scenario, application state synchronization is performed across computing environments by transmitting a synchronization file of synchronization files 226 from the first instance of the software application of computing system 202, over a network, to the second instance of the software application in cloud-based PC 318, described herein. In aspects, the synchronization file may be uploaded and stored in the cloud before it is received at the second computing environment.

In some embodiments, in response to determining that a file open in the first instance of the software application in the first computing environment (e.g, computing system 202) is not synchronized in the second computing environment (e.g., cloud-based PC 318), state manager 220 may transmit the file to the second computing environment for software application state synchronization.

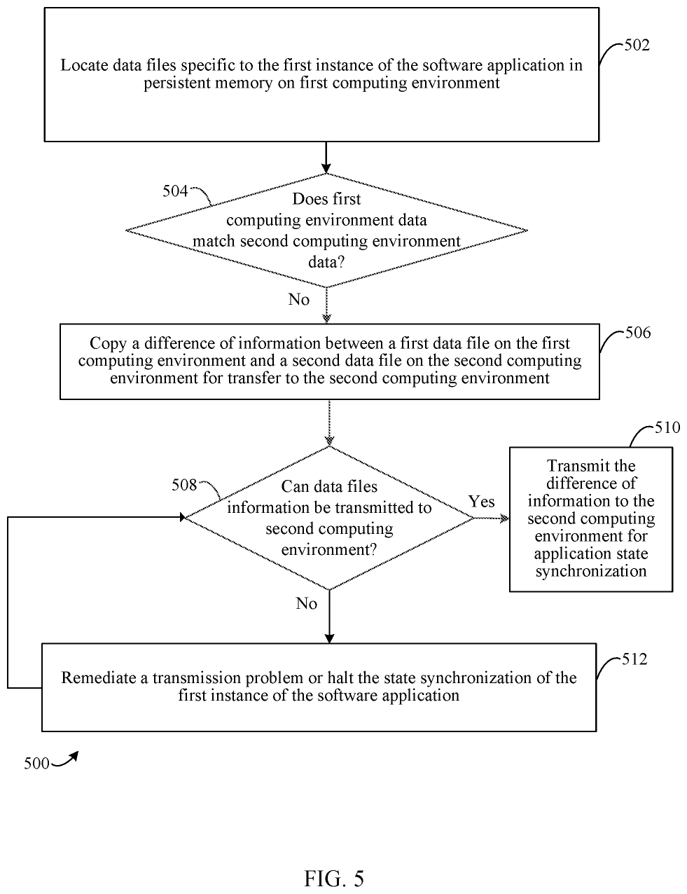

State managers may determine or verify whether a receiving computing environment is set up properly and has the proper files to perform an application state synchronization from a particular software application executing on a source computing environment. FIG. 5 shows a flowchart 500 of a method for verifying and/or synchronizing application information from persistent memory of a first computing environment to a second computing environment for application state synchronization, in accordance with an example embodiment.

In various aspects, flowchart 500 is implemented by systems shown in FIGS. 1-3, although the method is not limited to those implementations. For illustrative purposes, flowchart 500 will be exemplarily described with continued reference to FIGS. 1-3 where computing system 202 is the source computing environment and cloud-based PC 318 (and associated nodes and clusters of system 300) is the target computing environment (as provided for illustration in flowchart 400 of FIG. 4). Other structural and operational embodiments will be apparent to persons skilled in the relevant art(s) based on at least the discussion regarding flowchart 500, the systems of FIGS. 1-3, and flowchart 400.

In step 502, data files specific to the first instance of the software application are located in persistent memory on the first computing environment. The located data files store at least one of version information of the first instance of the software application, installation information, configuration information, dependent component information, user identity information, or access token information. For example, state manager 220 and/or state manager 332 may verify whether persistent software application information of the first instance of the software application (e.g., the located data files) is in sync between source computing system 202 and destination cloud-based PC 318, and may synchronize the information. In one embodiment, state manager 220 may locate the data files in persistent memory of memory storage 206, including data and/or files in an application install storage location, a registry, temporary files and/or folders, dependent components, user identities, access tokens, etc., (e.g., stored in a credential store installed on the source computing system 202). In another embodiment, state manager 220 may search storage locations that software applications generally use to store user identity information or may search for other credentials that may be installed. In instances where the software application is an application installer file (e.g., a .msix Windows® application installer file), the identity information may be stored within a sandbox (e.g., a limited area of storage space and memory that stores the resources the first instance of the software application utilizes) and may be copied for synchronization. An associated user identity stored in a credential storage space may also be copied for synchronization. For example, if identity information is stored in registry or temp folders or within a sandbox in memory storage 206, the identity information may be synchronized to destination cloud-based PC 318.

In step 504, in response to determining that a first data file of the located data files does not match a corresponding second data file on the second computing environment, the method proceeds to step 506. For example, in some embodiments, state manager 220 and state manager 332 may communicate via a network (e.g., network 112 and/or network 316) to determine or verify whether or not the located persistent data files or file data stored in memory storage 206 are stored in storage node 310N of cloud-based PC 318. State manager 202 and/or state manager 332 may determine a mismatch between the located data files, or file data, that is stored in source computing system 202 versus cloud-based PC 318.

In step 506, a difference of information between a first data file on the first computing environment and a second data file on the second computing environment is copied for transfer to the second computing environment. For example, state manager 220 may copy the located persistent application files or file data that is missing in storage node 310N for transfer to destination cloud-based PC 318.

In step 508, in instances where it is determined that information from the located data files can be transmitted to the second computing environment, the method proceeds to step 510. For example, where state manager 220 determines that the located persistent data files or file data, such as the copied difference of information (e.g., comprising version information, installation information, configuration information, dependent component information, user identity information, or access token information of the first instance of the software application) can be transmitted via a network to destination cloud-based PC 318, the method may proceed to step 510.

In step 510, the difference of information is transmitted to the second computing environment for state synchronization. For example, state manager 220 may transmit the copied persistent application data to destination cloud-based PC 318 via network interface 230 and network 316 (and/or via network 112) and the difference of information data may be stored in storage node 310N.

In step 508, in instances where it is determined that information from the located data files cannot be transmitted to the second computing environment, the method proceeds to step 512.

In step 512, a problem with transmitting information from the located data files to the second computing environment is remediated or the state synchronization of the first instance of the software application is halted. For example, (1) auto-remediation may be performed by determining an available port in the second computing environment, switching to a same port on the first computing environment, and transmitting the difference of information to the second computing environment via the available port for state synchronization, (2) manual-remediation may be caused by sending a message to a user with instructions for opening a particular port in the second computing environment, and transmitting the difference of information to the second computing environment via the particular port for state synchronization, or (3) the state synchronization of the first instance of the software application may be halted. In a case where remediation has been applied, control may flow back to step 508 to again determine whether the information from the located data files can be transmitted to the second computing environment.

For example, returning to FIGS. 2 and 3, in one embodiment, automated remediation may be performed where state manager 220 determines an available port in destination cloud-based PC 318 based on communication with state manager 332, and automatically causes a change in computing system 202 to utilize a same port for communication via network interface 230 with cloud-based PC 318. State manager 220 causes the copied difference of information to be transmitted to cloud-based PC 318 via network 316 (and/or network 112) on the automatically set up port. In another embodiment, manual remediation may be performed where state manager 220 causes communication with a user via user interface and provides the user with instructions for opening a particular port in computing system 202 for communication with cloud-based PC 318. If the port is set up, state manager 220 causes the copied difference of information to be transmitted to cloud-based PC 318 via network 316 (and/or network 112) on the port setup by the user. Otherwise, if automated or manual remediation fails or the user declines remediation, then state manager 220 may stop the application state synchronization process and provide an error message to the user via the user interface.

State manager 220 also determines whether persistent application information such as current file(s) (e.g., application file(s) 224) that are in use in the software application executing in the first computing environment (e.g., a first instance of an application executing on computing system 202) are the same and/or in sync with files stored in the second computing environment (e.g., application files 304 stored in storage node 310N of cloud-based PC 318). If the files are not stored in cloud-based PC 318, or the files that are stored in cloud-based PC 318 are not in sync (e.g., in the same state), then state manager 220 causes the current files to be transmitted to cloud-based PC 318. In some embodiments, cloud-based storage may be utilized to sync the files for use in cloud-based PC 318. For example, the current application file(s) 224 may automatically be saved to a cloud based storage drive for syncing with application files 204 in cloud-based PC 318.

State managers in a source computing environment and/or a destination computing environment may also determine or verify whether network configuration in the destination computing environment is set up properly to perform an application state synchronization that allows a user to change computing environments and have an application and file automatically synchronized in the destination computing environment. In some embodiments, the software application (or first instance of the software application) that is executing in source computing system 202 may comprise a browser. The browser may keep track of URLs that it has opened and may save the URL information as application agnostic state information in synchronization file(s) 226. State manager 220 may determine whether the destination computing environment (e.g., cloud-based PC 318) has access to those URLs and whether ports that may be associated with those URLs are available.

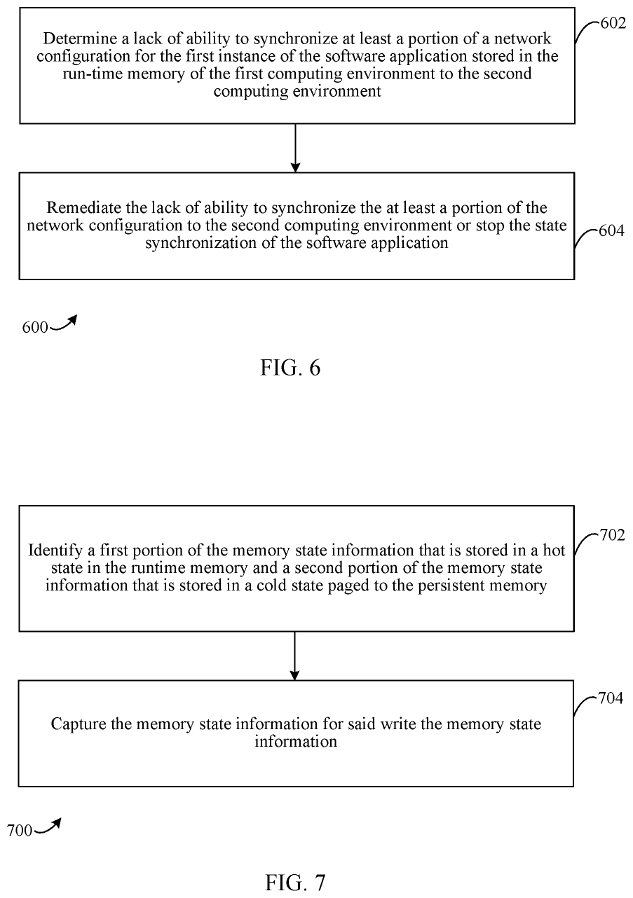

For instance, FIG. 6 shows a flowchart 600 of a method to remedy a difference in non-persistent network configuration information between a first computing environment and a second computing environment for application state synchronization, in accordance with an example embodiment.

In various aspects, flowchart 600 is implemented by systems shown in FIGS. 1-3, although the method is not limited to those implementations. For illustrative purposes, flowchart 600 will be exemplarily described with continued reference to FIGS. 1-3 where computing system 202 is the source computing environment and cloud-based PC 318 (and associated nodes and clusters of system 300) is the target computing environment (as provided for illustration in flowcharts 400 and 500). Other structural and operational embodiments will be apparent to persons skilled in the relevant art(s) based on at least the discussion regarding flowchart 600, the systems of FIGS. 1-3, and flowcharts 400 and 500.

In step 602, a lack of ability is determined for synchronizing at least a portion of a network configuration for the first instance of the software application stored in the run-time memory of the first computing environment to the second computing environment. The network configuration comprises at least one of access to a uniform resource locator (URL) or availability of a network port. For example, based on a current network configuration stored in run-time memory of memory storage 206 on source computing system 202, the software application (or first instance of the software application) that is executing in source computing system 202 may utilize one or more ports, one or more IP addresses, or one or more URLs. State manager 220 and state manager 332 may communicate via a network (e.g., network 112 and/or network 316) to determine or verify whether or not the current network configuration of source computing system is available or accessible in destination cloud-based PC 318. State manager 202 may determine that one or more aspects of the current network configuration is not available or accessible in destination cloud-based PC 318.

In step 604, the lack of ability to synchronize the at least a portion of the network configuration to the second computing environment may be remediated. For example, in an auto-remediation process, state manager 220 may communicate with state manager 332 to determine if the same port(s) used by the software application (e.g., first instance of the software application) executing in source computing system 202 can be made available on destination cloud-based computing system 318. If the port(s) can be made available, the network configuration is reconfigured in cloud-based PC 318 to the available port(s). If the port(s) are not available, state manager 220 will determine other port(s) that are available in cloud-based PC 318, and switch to those port(s) on source computing system 202.

Alternatively, or in addition, steps are provided for performing manual remediation of the lack of ability to synchronize the at least a portion of the network configuration to the second computing environment via a user interface. For example, if one or more aspects of auto remediation was available or utilized, state manager 220 may send a message to the user, for example, via a user interface, indicating steps or instructions for manually setting up a suitable network configuration for implementing the software application state synchronization. In one embodiment, the message to the user may indicate that a URL utilized by the first software application was not available for use in destination cloud-based PC 318 and/or that it could not be automatically opened due (e.g., due to a network firewall and lack of access to make the change). The message may provide, for example, a link to open the URL on destination cloud-based PC 318, or may provide step by step instructions for the user to open links in their network router.

Alternatively, or in addition, the state synchronization of the software application may be stopped. For example, if the user indicates via the user interface that they do not want automated or manual remediation of the lack of ability to synchronize the at least a portion of the network configuration to the second computing environment, then state manager 220 may stop the application state synchronization process and provide an error message to the user via the user interface.

A state manager in a source computing environment may also identify and synchronize memory state information to the destination computing environment. For instance, FIG. 7 shows a flowchart 700 of a method for capturing memory state information stored in a hot state in runtime memory and/or in a cold state paged to persistent memory for application state synchronization, in accordance with an example embodiment.

In various aspects, flowchart 700 is implemented by systems shown in FIGS. 1-3, although the method is not limited to those implementations. For illustrative purposes, flowchart 700 will be exemplarily described with continued reference to FIGS. 1-3 where computing system 202 is the source computing environment and cloud-based PC 318 (and associated nodes and clusters of system 300) is the target computing environment (as provided for illustration in flowchart 400 of FIG. 4). Other structural and operational embodiments will be apparent to persons skilled in the relevant art(s) based on at least the discussion regarding flowchart 700, the systems of FIGS. 1-3, and flowchart 700.

In step 702, a first portion of the memory state information that is stored in a hot state in the runtime memory is identified and a second portion of the memory state information that is stored in a cold state paged to the persistent memory is identified. For example, state manager 220 may save memory state information of the first software application executing in computing system 202 to a data structure in synchronization file(s) 226 for a software application state synchronization process. State manager 220 may first identify application-specific data stored in non-persistent memory (e.g., RAM) of memory storage 206 including a portion of the data that is stored in a “hot state” in RAM and a portion of the data that has been paged to non-volatile storage (e.g., disk) of memory storage 206 in a “cold state.” In other words, state manager 220 may identify the different sectors in memory storage 206 that the software application is using, and determine how many of the sectors are in the hot state versus the cold state. Data stored in the hot state may be formatted differently than data stored in the cold state.

In step 704, the memory state information for the writing of the memory state information (e.g., for the writing of the memory state information in step 406 of flowchart 400) is captured. For example, (1) the first portion of the memory state information may be captured, and the second portion of the memory state information may be captured. The captured first portion of the memory state information and the captured second portion of the memory state information may be written to the data structure in the synchronization file(s) 226 according to a hot state format and a cold state format respectively, (2) the first portion of the memory state information may be captured and paged to the persistent memory according to the cold state format. The first portion of the memory state information and the second portion of the memory state information may be captured from the persistent memory, and the captured first portion of the memory state information and the captured second portion of memory state information may be written to the data structure in synchronization file(s) (226) according to the cold state format, or (3) the second portion of the memory state information stored in the cold state in persistent memory may be un-paged and stored in runtime memory according to the hot state format. Then, the first portion of the memory state information and the second portion of the memory state information may be captured from the runtime memory and may be written to the data structure in the synchronization file(s) 226 according to the hot state format.

For example, state manager 220 may store a first portion of memory state information of the first software application executing in computing system 202, from non-persistent memory (e.g., RAM) of memory storage 206, to a data structure of synchronization file(s) 226 according to its hot state format. A second portion of the memory state information that was earlier paged to persistent memory is then stored to the data structure of synchronization file(s) 226 according to its cold state format. In this manner, the first portion of memory state information may be stored in non-persistent memory (or runtime memory) of cloud-based PC 318, and the second portion may be stored in persistent memory of cloud-based PC 318.

Alternatively, or in addition, state manager 220 may page the first portion of the memory state information from non-persistent memory to persistent storage of memory storage 206 according to a cold state format, and then store the first portion of the memory state information and the second portion of the memory state information from persistent storage to the data structure of synchronization file(s) 226 according to the cold state format. In this manner, the first portion of memory state information and the second portion of memory state information may be stored in persistent storage in cloud-based PC 318.

Alternatively, or in addition, state manager 220 may un-page the second portion of the memory state information from persistent memory and store the second portion of the memory state information to non-persistent storage of memory storage 206 according to a hot state format. State manager 220 may then store the first portion of the memory state information and the second portion of the memory state information from the non-persistent storage to the data structure of synchronization file(s) 226 according to the hot state format. In this manner, the first portion of memory state information and the second portion of memory state information may be stored in non-persistent storage in cloud-based PC 318. The choice of using the first method, the second method, or the third method (e.g., storing in non-persistent memory and persistent memory, storing only in persistent memory, or storing only in non-persistent memory in cloud-based PC 318), may depend on storage capacity or availability of the non-persistent memory versus the persistent memory in cloud-based PC 318.

As described above, with respect to at least FIG. 4, non-persistent application execution state information, such as information based on render commands, is identified by system filter 208 and stored in the data structure of synchronization file(s) 226 for software application synchronization to cloud-based PC 318. The identified execution state information that is specific to the first instance of the software application may include, for example, active window or sub window handles, open menus, tabs, toolbars, ribbons, a current page (e.g., an application or web page), characteristics of mouse selection, characteristics of keyboard selection, or characteristics of pen input. Execution state information for a browser (e.g., the first software application) may include an open website and scrolling status to a particular page on the website. Execution state for a text editor may include a current page.

Moreover, application agnostic information utilized by the first software application executing in source computing system 202 may be saved to the data structure of synchronization file(s) 226 for state synchronization to cloud-based PC 318. For example, state manager 220 captures the application agnostic state information and writes it to the data structure. The application agnostic state information may include mouse cursor properties, keyboard cursor properties, window display properties, or opened URLs. More specifically, application agnostic state information may include mouse dots-per-inch (DPI) aware x, y coordinates and other mouse properties like cursor color, icon properties, etc., keyboard DPI aware x, y coordinates and other keyboard properties like cursor color, icon properties, blink rate, etc., window position, size, focus, and z-order such as DPI aware window x, y coordinates, width and height, focus, and z-order.

In some embodiments, the first software application (or first instance of the software application) executing in computing system 202 may be a browser. The agnostic state information for the browser may include URLs opened by the browser where the browser keeps track of URLs that it has opened.

In some embodiments, for example, where the destination software application receiving state synchronization information is a different or an alternate application relative to the source application, some of the application-specific state information (e.g., network configuration state or memory state information) may function as application agnostic information for the purpose of applying state data in the destination alternate application. For example, where the source and alternate destination applications are designed to perform the same or similar functions (e.g., both are .pdf file editors or both are .pdf file readers), non-persistent network configuration information (e.g., URLs, network ports, IP address used) or the software application's memory state information that is stored in non-persistent runtime memory may be utilized to synchronize the application state to the alternate application. More specifically, in one example, there are some .pdf file readers that can restore the state of the Adobe® Reader® application. In this regard, any memory state that has a temporary .pdf file (e.g., .pdf temp file) can be opened by an alternate application that knows how to read the .pdf temp file (e.g., based on documented file standards). Moreover, sibling alternate applications can sometimes read each other's states (e.g., Adobe® Lightroom® and Adobe® Photoshop®). As such, certain memory state information or network configuration state information items stored in the data structure of the synchronization file(s) 226 can be read by sibling alternate applications (e.g., photo editing templates, workflows) and may be applied in the destination sibling alternate application to synchronize the application state. However, the execution state information (e.g., active window or sub window handles, open menus, tabs, toolbars) of a first application may not be applicable for state synchronization to an alternate second application in the second computing environment.

In some embodiments, once the software state information of the first software application executing on the first computing environment has been stored in synchronization file(s) 226 and any desired verification processes for persistent and/or non-persistent application information has been performed, the first software application on source computing system 202 may be closed.

Furthermore, state manager 220 may cause the gathered state information (e.g., including any of memory state information, execution state information, or application agnostic state information) of a first application to be transmitted via network 112 and/or network 316 to the destination computing environment (e.g., cloud-based PC 318) for software application state synchronization, so that a user may open a second instance of the application, or an alternate application, and continue working at the same or similar state as the state left-off at in the first application. State manager 220 may notify state manager 332 via network 316 that the state synchronization file(s) 226 were successfully copied and to proceed with synchronizing (applying) the software application state information in the destination computing environment (e.g., cloud-based PC 318).

In the destination computing environment (e.g., cloud-based PC 318), state manager 332 reads the state synchronization file(s) 226 and launches a new instance of the software application. If the application is already running and supports only one instance at a time, state manager 332 may cause a prompt to the user via a user interface to allow state manager 332 to restart the application in the new state. At this point, based on the verification processes described herein, the following states of the application should be in sync at the destination computing environment: (1) the persistent application information (e.g., application version information, application installation information, configuration information, dependent components, and user identity information), the file(s) in use in should be open in the application, and non-persistent network configuration state (e.g., ports, URLs, IP addresses) should be setup in the destination computing environment (e.g., cloud-based PC 318).

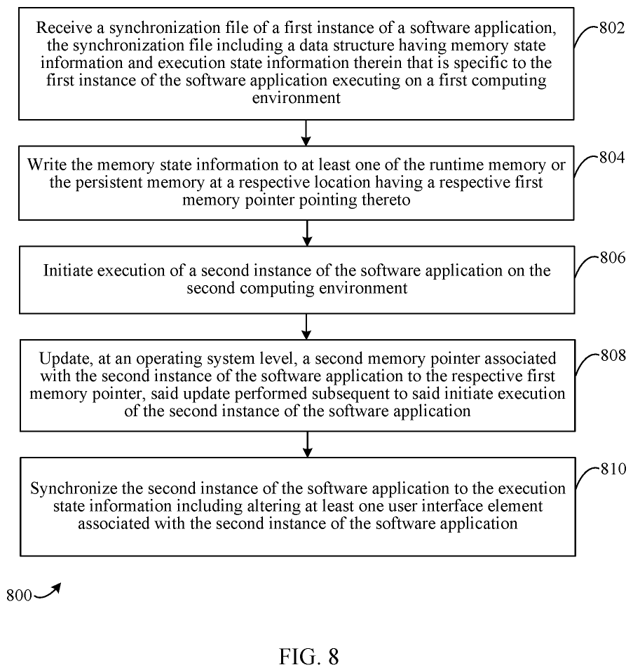

Referring now to FIG. 8, a flowchart 800 is shown for application state synchronization across computing environments to a second instance of a software application, in accordance with an example embodiment. In various aspects, flowchart 800 is implemented by systems shown in FIGS. 1-3, although the method is not limited to those implementations. For illustrative purposes, flowchart 800 will be exemplarily described with continued reference to FIGS. 1-3 where computing system 202 is the source computing environment and cloud-based PC 318 (and associated nodes and clusters of system 300) is the target computing environment (as provided for illustration in flowchart 400 of FIG. 4). Other structural and operational embodiments will be apparent to persons skilled in the relevant art(s) based on at least the discussion regarding flowchart 800, the systems of FIGS. 1-3, and flowchart 400.

Flowchart 800 begins with step 802. In step 802, a synchronization file of a first instance of a software application is received, the synchronization file includes a data structure having memory state information and execution state information therein that is specific to the first instance of the software application executing on a first computing environment. For instance, the synchronization file transmitted from the source computing environment (e.g., computing system 202) in step 412 of flowchart 400 in FIG. 4, described above, is received by a target second computing environment (e.g., system 300) and stored as one of synchronization file(s) 306. The target second computing environment may be specified in a user profile, by manual or automated selection, and/or the like in various aspects. As described herein, a synchronization file includes a data structure having state information, comprising memory state information and/or execution state information that is specific to a software application from a source first computing environment, in embodiments. Alternatively, or in addition, the data structure may store application agnostic state information. A synchronization file(s) received at a target computing environment is provided to and/or utilized by a state manager, e.g., state manager 332 of system 300 in this example scenario.

In step 804, the memory state information is written to at least one of the runtime memory or the persistent memory at a respective location having a respective first memory pointer pointing thereto. For example, state manager 332 is configured to write the memory state information from received synchronization file(s) 226 into a memory of a compute node such as node 308A in which cloud-based PC 318, the target computing environment, executes at a pointer location. In aspects, when the size of the runtime memory for the target computing environment is large enough for all of the memory state information, the memory state information is written to the runtime memory. In other aspects, a portion is written to the runtime memory (e.g., hot state) and another portion is written to the persistent memory (e.g., cold state) of the target computing environment.

In step 806, execution of the second instance of the software application is initiated at a second computing environment. For instance, cloud-based PC 318 of system 300, the target second computing environment, is caused to execute the second instance of the software application associated with the received synchronization file, e.g., by state manager 332.

In step 808, at an operating system level, a second memory pointer associated with the second instance of the software application is updated to the respective first memory pointer subsequent to initiating execution of the second instance of the software application. For example, state manager 332 is configured to update the memory location pointer for the now-executing software application, e.g., as set by cloud-based PC 318, to the memory location pointer(s) at which the memory state information was written to in the runtime memory and/or the persistent memory of cloud-based PC 318. Accordingly, the software application executing at cloud-based PC 318 has pointers to memory that correspond to the memory state information associated with the first instance of the software application as it was executing at the source first computing environment (e.g., computing system 202).

In step 810, the second instance of the software application is synchronized to the execution state information including altering at least one user interface element associated with the second instance of the software application. For instance, state manager 332 is configured to synchronize the second instance of the software application executed by cloud-based PC 318 in step 806 to the execution state of the source first computing environment (e.g., computing system 202). In embodiments, this synchronization includes state manager 332 providing render commands corresponding to the execution state information to a renderer associated with cloud-based PC 318 such that the executing second instance of the software application is rendered to the same execution state as it was executing at the source first computing environment (e.g., computing system 202).

In another aspect, where restoring the non-persistent application information such as the memory state information at the destination computing environment (e.g., cloud-based PC 318), the restoring process may include: (1) copying memory related contents from synchronization file(s) 226 into the destination computing environment's non-persistent memory (e.g., RAM), (2) identifying a location where the application specific data is stored in the destination computing environment RAM, (3) given that the application was recently launched, none of its memory should be paged to disk, but if any memory was paged to disk, state manager 332 may un-page the memory from disk to RAM, (4) at an operating system (OS) level, the pointer to the location or address of application's current memory on RAM is swapped to the location or address of the newly copied RAM data from the synchronization file(s) 226. Given that there is no change to the application itself, and that the RAM address translation happens at OS level, the application continues to execute normally as designed.

The software state synchronization process may further include restoring the non-persistent application information (e.g., execution state information) at the destination computing environment as follows: (1) run the rendering commands on the destination computing environment (cloud-based PC 318) to bring the following items to be in sync with the original state of application on the source computing environment (e.g., computing system 202) when the state synchronization was initiated: active window and sub-window handles, open menus, tabs, toolbars, ribbon etc., and current page, mouse and keyboard selections, etc.

As described herein, state information specific to the first instance of the software application (e.g., software application(s) 222) is synchronized in the destination second computing environment (e.g., cloud-based PC 318) relative to the source first computing environment (computing system 202), and the synchronized state information includes at least one of version information of the first instance of the software application, installation information, configuration information, dependent component information, user identity information, or access token information stored in the persistent memory of memory storage 206, files (e.g., application files 224) to be opened in the second instance of the software application (e.g., application(s) 330), and a network configuration for the second instance of the software application stored in the run-time memory of the second computing environment.

As described herein, the processing system (e.g., state manager 332) synchronizes the second instance of the software application (e.g, application(s) 330) to the execution state information (e.g, from synchronization file(s) 226) including altering at least one user interface element associated with the second instance of the software application, by executing, in the second computing environment (e.g., cloud-based PC 318) render commands that are based on the execution state information. The at least one user interface element associated with the second instance of the software application may comprise at least one of: active window or sub window handles, open menus, tabs, toolbars, or ribbons, a current page, a current web page, characteristics of mouse selection, characteristics of keyboard selection, or characteristics of pen input.

The data structure of the synchronization file(s) 226 received in the second computing environment (e.g., cloud-based PC 318) may further include agnostic state information therein that is agnostic relative to the first instance of the software application (e.g, software application(s) 222), and the processing system (e.g., state manager 332) synchronizes the second instance of the software application (e.g., application file(s) 304) in the second computing environment (e.g., cloud-based PC 318) to the agnostic state information. The agnostic state information may comprise at least one of: mouse cursor properties, keyboard cursor properties, window display properties, or URLs.

The processing system (e.g., state manager 332) synchronizes the second instance of the software application (e.g., application(s) 330) in the second computing environment (e.g, cloud-based PC 318) to the agnostic state information by applying window display properties of the agnostic state information in the second computing environment including at least one of window position, size, focus, z-order, dots-per-inch aware window x, y coordinates, width, or height. In other words, the software application state synchronization process may further include restoring the application agnostic state information that may include: mouse DPI aware x, y coordinates and other mouse properties such as cursor color, icon properties, etc., keyboard DPI aware x, y coordinates and other keyboard properties such as cursor color, icon properties, blink rate, etc., and effective window position, window size, focus, and z-order (e.g., DPI aware window x, y coordinates, width, height, focus and z-order) received from the source first computing environment (e.g., computing system 202).

In some aspects, upon successful completion of software application state synchronization in the destination computing environment (e.g., cloud-based PC 318), the state manager of the destination computing environment (and/or of the source computing environment—computing system 202) may cause a message to be displayed via a user interface indicating that the application was restored in a same or similar state on the destination computing environment. Furthermore, the state managers in the source and/or destination computing environments may perform a “clean-up” process, for example, to remove synchronization file(s) 226 and/or 306 in storage locations on one or both computing environments to conserve storage.

In some aspects, for example, in instances where a user moves back to use the application on the source computing environment, without having made any changes in the destination computing environment since the state was synchronized from the source computing environment to the destination, the source application may again be activated in the source computing environment, in the same state as it was before the synchronization process began.

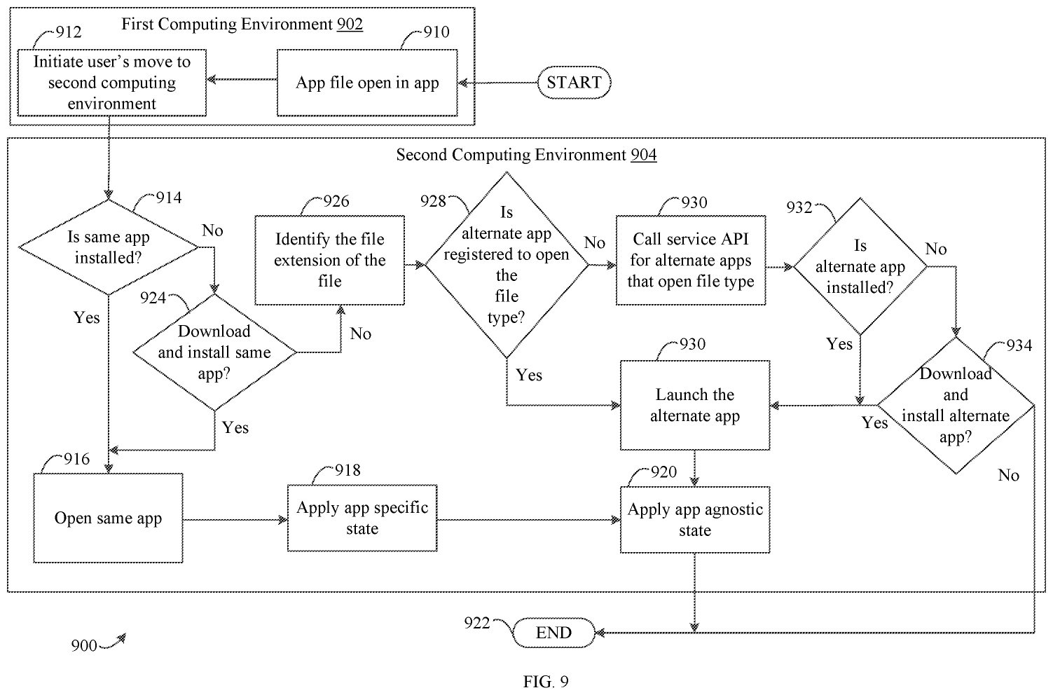

In instances where the destination second computing environment does not have available a second instance of the same software application(s) that is executed in the source first computing environment, an alternate application that is operable to process a same file(s) that was open in the first instance of the application, may be opened and synchronized with at least a portion of the state information of the first instance of the software application. For example, FIG. 9 depicts a system flow diagram 900 illustrating a sequence of actions that implement application state synchronization across computing environments to a same or an alternate software application, in accordance with an example embodiment. System flow diagram 900 comprises a first computing environment 902 (e.g., a source computing environment) and a second computing environment 904 (e.g., a destination computing environment), as described variously herein with respect to FIGS. 1-3. System flow diagram 900 includes aspects in which an alternate software application may be utilized at second computing environment 904 for a software application state synchronization. For example, an alternate software application may be utilized on second computing environment 904 in instances where the application being synched from the first computing environment 902 is not installed or available on second computing environment 904. Other structural and operational embodiments will be apparent to persons skilled in the relevant art(s) based on the discussion regarding system flow diagram 900. As described with respect to flow charts 400-800, the first computing environment 902 (the source) may be similar or substantially the same as computing system 202, and the second computing environment 904 (the destination) may be similar or substantially the same as cloud-based PC 318. However, the disclosure is not limited in this regard and any suitable computing environment(s) may be utilized for the first computing environment 902 and the second computing environment 904.

As shown, system flow diagram 900 exemplarily illustrates a system flow including first computing environment 902 and second computing environment 904, where in step 910, an application file is open in a software application executing in first computing environment 902. In step 912 a user “move,” or a trigger for application state synchronization across computing environments, is initiated for causing the transfer of application state information to from first computing environment 902 to second computing environment 904. The state synchronization process may be initiated by a user at first computing environment 902 or at second computing environment 904, or it may be initiated automatically by a state manager(s) in one or both of first computing environment 902 or second computing environment 904. Moreover, one or more of the actions described in system flow diagram 900 are performed without user input (e.g., automatically), with user input (e.g., manually), or in a combination thereof, by a state manager (e.g., state manager 220) of first computing environment 902 and/or a state manager (e.g., state manager 332) of second computing environment 904, according to aspects.

As described herein, aspects enable the opening of an application file in an alternate application if a second instance of the same application executing in first computing environment 902 is not used or available for use in second computing environment 904 for application state synchronization across computing environments.

In step 914, a state manager, such as any of those described herein, is configured to determine if the software application(s) executing at first computing environment 902 exists in the second computing environment 904 in which the end-user would like to open their software application(s) with state synchronization. Second computing environment 904 is queried by a source state manager of first computing environment 902, and it is determined by a state manager of second computing environment 904 in step 914 if the software application is installed at the second (target) computing environment. If so, then in step 916, the software application is opened in second computing environment 904. In steps 918 and 920, the application-specific and/or application agnostic states of the first computing environment 902 are applied to the software application in the second computing environment 904. In this manner, the software application is synchronized at second computing environment 904, and system flow diagram 900 ends at step 922.

In step 914, if the same software application is not installed at second computing environment 904, in step 924, it is determined by a state manager at second computing environment 904 whether the same software application is to be downloaded and installed in second computing environment 904. For example, in some embodiments, a state manager (at first or second computing environment) may cause a user interface to ask a user for permission to download the same software application at second computing environment 904. If it is determined to download the same software application, the state manager of second computing environment 904 downloads and installs the same software application. In step 916, the state manager at second computing environment 904 opens the same software application, as described above, and continues through steps 918 and 920 to apply application specific and/or application agnostic states to the same software application until system flow diagram 900 ends at step 922.

If in step 914, it is determined that the same software application is not installed in second computing environment 904, and it is determined in step 924, that the same software application is not to be downloaded and/or installed in second computing environment 904, in step 926, a file extension for a file(s) open in the software application executing in first computing environment 902 is determined. Based on the file extension, in step 928, a determination is made by the state manager of second computing environment 904 as to whether an alternate software application(s) is registered at second computing environment 904 to open the type of file associated with the file extension. If an alternate software application is so registered, and is automatically-selected or user-selected for use, in step 930, the alternate software application is launched in second computing environment 904. In step 920, a portion or subset of application state information from first computing environment 902 is applied to the respective alternate application(s) for state synchronization. For example, application agnostic state information from first computing environment 902 may be applied to the alternate application(s). In some aspects, if the state synchronization is to an alternate software application, second computing environment 904 may execute a different operating system than first computing environment 902. System flow diagram 900 ends at step 922. As described above, in certain instances, such as where the alternate software application in second computing environment 904 is designed to perform the same function as the first software application (e.g., Adobe Acrobat Reader and another .pdf file reader), all or a portion of application specific state information received from first computing environment 902 may be applied in second computing environment 904 for state synchronization to the alternate application.

If, in step 928, it is determined that an alternate software application is not registered in second computing environment 904 for opening files associated with the identified file extension, in step 930, the state manager makes a call to a service API (e.g., one of APIs 320) to identify alternate software application(s) capable of opening the file type. If, in step 932, it is determined that the alternate software application is installed in second computing environment 904, in step 930, the alternate software application is launched. In step 920, a portion or subset of the application state(s) received from first computing environment 902 are applied in the alternate application in second computing environment 904 for application state synchronization. System flow diagram 900 then proceeds to step 922 and ends.

If, in step 932, the alternate software application is not installed at second computing environment 904, in step 934, it is determined at second computing environment 904, by its state manager, whether the alternate software application is to be downloaded and installed. For example, in some embodiments, the state manager may cause a user interface to ask a user for permission to download an alternate software application(s). If it is determined to download the alternate software application(s), the state manager downloads and installs the alternate software application(s). If so, the state manager of second computing environment 904 proceeds to download and install the alternate application, and in step 930, opens the downloaded alternate software application, as described above. In step 920 the state manager applies at least a portion or subset of the application state(s) from first computing environment 902 to the alternate software application. If, in step 934, it is determined not to download and install the alternate application, the user may be provided with an error message, in aspects. In step 922, system flow diagram 900 ends.

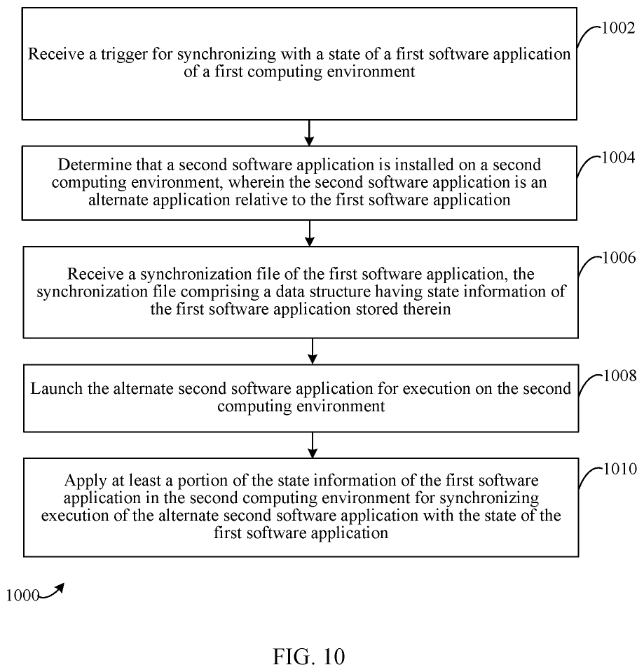

Accordingly, application state synchronization across computing environments is implemented in various ways. For instance, referring now to FIG. 10, a flowchart 1000 is shown for application state synchronization across computing environments to an alternate software application, in accordance with an example embodiment. In various aspects, flowchart 1000 is implemented by systems shown in FIGS. 1-3, although the method is not limited to those implementations. For illustrative purposes, flowchart 1000 will be exemplarily described with continued reference to FIGS. 1-3 where computing system 202 is the first (source) computing environment and cloud-based PC 318 (and associated nodes and clusters of system 300) is the second (target) computing environment (as provided for illustration at least in flowchart 400 of FIG. 4). Other structural and operational embodiments will be apparent to persons skilled in the relevant art(s) based on at least the discussion regarding flowchart 1000, the systems of FIGS. 1-3, and flowcharts 400-800, and flow diagram 900.

Flowchart 1000 begins with step 1002. In step 1002, a trigger is received for synchronizing with a state of a first software application(s) of a first computing environment. For example, as described above with respect to FIG. 4, an example second computing environment may comprise cloud-based PC 318 and an example first computing environment may comprise computing system 202. The trigger may be received by state manager 332 for synchronizing state information from a first application executing in computing system 202. The trigger may be an automated or manual trigger such as a synchronization command or instruction initiated based on a user input (e.g., manual) or a system input (e.g., automated) from the computing system 202, cloud-based PC 318, an external application or website, etc. In some embodiments, state manager 332 (executing in the background) may a receive a call to query for application information or a state synchronization object and may retrieve the information or state synchronization object from computing system 202.

In step 1004, it is determined that a second software application is installed on a second computing environment, wherein the second software application is an alternate application relative to the first software application. For example, state manager 332 may determine that a first software application(s) executing in computing system 202, which the user may wish to open with state synchronization in cloud-based PC 318, is not available for use in in cloud-based PC 318. If it is not available, a determination may be made as to whether an alternate second software application(s) is available for use, in place of the first software application, in cloud-based PC 318. The alternate second software application may be automatically selected or user-selected via a user interface. The alternate second software application may be an application that can open and process a file that is the same type of file(s) open in the first software application, and can restore at least a portion of the application state (e.g., at least application agnostic state information) of the first software application.

In one example, a first software application executing in first computing system 202 may comprise Adobe® Acrobat® Reader® with an open .pdf file, and may store state information in a pdf temp file. An alternate second application that is available to open the same .pdf file in cloud-based PC 318 may be operable to read the pdf temp file and thereby substantially restore the application state from the Adobe® Acrobat® Reader®. Example alternate application .pdf file readers include Javelin PDF Reader, Google Drive, Nitro Reader, etc. Moreover, some sibling applications (e.g., Adobe® Lightroom® and Adobe® Photoshop®) may be operable to read certain items of each other's application specific memory state information, such as photo editing templates, workflows, etc. for performing application state synchronization from computing system 202 to an alternate application in cloud-based PC 318. Alternatively, rather than a purpose-built .pdf file reader, the alternate application may be a browser application (e.g., Chrome PDF Viewer) that is operable to open a .pdf file in cloud-based PC 318, but may only be operable to restore a portion of the state information from Adobe® Acrobat® Reader®, such as application agnostic state data (e.g., window size, window focus, z-order). In another example, the first software application executing in first computing system 202 may comprise a browser application accessing a web page(s). The alternate second application in this example, may comprise another type of browser that is operable to access and navigate the same webpage(s) for application state synchronization.

Step 1004 may be repeated for applications that the first software application depends on (e.g., child processes, complementary applications). In some embodiments, the first software application may be closed on first computing system 202 after state synchronization data has been stored.

In step 1006, a synchronization file of the first software application is received, the synchronization file comprises a data structure having state information of the first software application stored therein. For example, synchronization file(s) 226 may be received by state manager 332. The synchronization file(s) may include application specific state information and/or application agnostic information. The application specific state information may include network configuration information such as URLs and/or network ports that were utilized on the first computing system 202, memory state information such as data that was stored in non-persistent memory (or paged to persistent memory) by the first software application on the first computing system 202, and/or application agnostic information. The application agnostic information in the synchronization file may include, for example, (1) mouse information such as dots per inch (DPI) aware x, y coordinates and other properties such as cursor color, icon properties, etc., (2) keyboard information such as DPI aware x, y coordinates and other keyboard properties such as cursor color, icon properties, blink rate, etc., (3) window properties such as DPI aware window x, y, coordinates, position, size (e.g., width and height), window focus, and/or z-order, and (4) state information such as current page, mouse and/or keyboard selection(s) that are agnostic to the first software application in use on the first computing system 202.

In step 1008, the alternate second software application(s) is launched for execution on the second computing environment. For instance, execution may be initiated for the alternate second application and any child processes or complementary applications of the alternate second application, in cloud-based PC 318. In some embodiments, the first software application that is open and/or locked in first computing system 202, may be closed in first software computing system 202.

In step 1010, at least a portion of the state information of the first software application is applied in the second computing environment for synchronizing execution of the alternate second software application with the state of the first software application. For example, all or a portion of a state of the first software application and/or a file that was open in the first application, that was based on user activity in and/or execution of the first software application, and that was captured in the synchronization file of the first software application may be applied to the alternate second application in the cloud-based PC 318 depending on which aspects of the state information the alternate second application is operable to restore. As described above, in some alternate second applications, only application agnostic information may be restored. Other alternate second applications may be operable to restore all or a portion of memory state information and/or network (e.g., URL, port information).

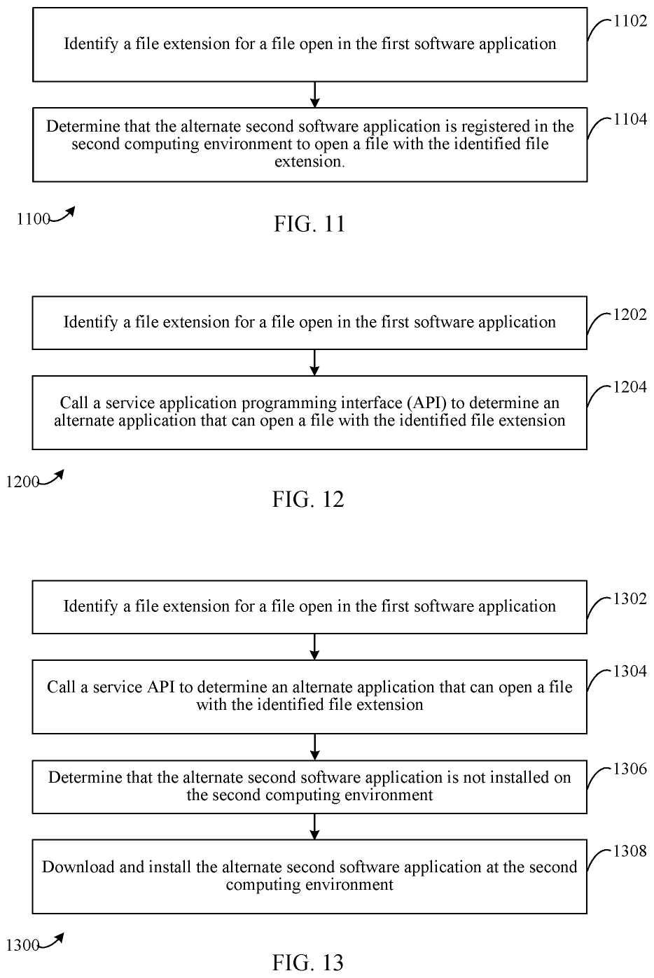

In some aspects, a state manager may determine an alternate application for state synchronization in a second computing environment based on a file extension of a first application executing in a first computing environment. For instance, FIGS. 11-13 include flowcharts 1100, 1200, and 1300, respectively, that each shows a method for utilizing a file extension to determine an alternate application for performing application state synchronization across computing environments, in accordance with an example embodiment. In various aspects, flowcharts 1100, 1200, and 1300 are implemented by systems shown in FIGS. 1-3, although the methods are not limited to those implementations. For illustrative purposes, flowcharts 1100, 1200, and 1300 will each be exemplarily described with continued reference to FIGS. 1-3 where computing system 202 is the first (source) computing environment and cloud-based PC 318 (and associated nodes and clusters of system 300) is the second (target) computing environment (as provided for illustration at least in flowchart 400 of FIG. 4). Other structural and operational embodiments will be apparent to persons skilled in the relevant art(s) based on at least the discussion regarding flowcharts 1100, 1200, and 1300, the systems of FIGS. 1-3, and flowcharts 400-800 and 1000, and flow diagram 900.

Referring to FIG. 11, flowchart 1100 begins with step 1102. In step 1102, a file extension for a file open in the first software application is identified. For example, prior to determining that the second software application is installed on the second computing environment, state manager 332 determines a file(s) extension for a file that was open in the first software application in first computing system 202.

In step 1104, it is determined that the alternate second software application is registered in the second computing environment and can open a file with the identified file extension. For example, state manager 332 determines that the alternate second software application (e.g., an application of application file(s) 304) is registered in cloud-based PC 318 and that it can open a file having the identified file extension. The method may proceed with state synchronization as indicated above beginning at step 1004 of flow chart 1000 where it is determined that the second software application is installed on the second computing environment and the second software application is an alternate application.

Referring to FIG. 12, flowchart 1200 begins with step 1202. In step 1202, a file extension for a file open in the first software application is identified. For example, prior to determining that the second software application is installed on the second computing environment, state manager 332 determines a file(s) extension for a file that was open in the first software application in first computing system 202.

In step 1204, a service application programming interface (API) is called to determine an alternate application that can open a file with the identified file extension. For example, state manager 332 may call a service API. The API may access an online store that may comprise an application compatibility testing database or other databases indicating which software applications are operable to open files with the identified file type. If such a software application is identified, state manager 332 may proceed with state synchronization as indicated above beginning at step 1004 of flow chart 1000, where it is determined that the identified software application is installed on the cloud-based PC 318, and that it is a second software application that is an alternate application relative to the first software application and that may be utilized for state synchronization (e.g., the alternate application may have been installed on cloud-based PC 318 but may not have been registered to open a file of the identified file type).

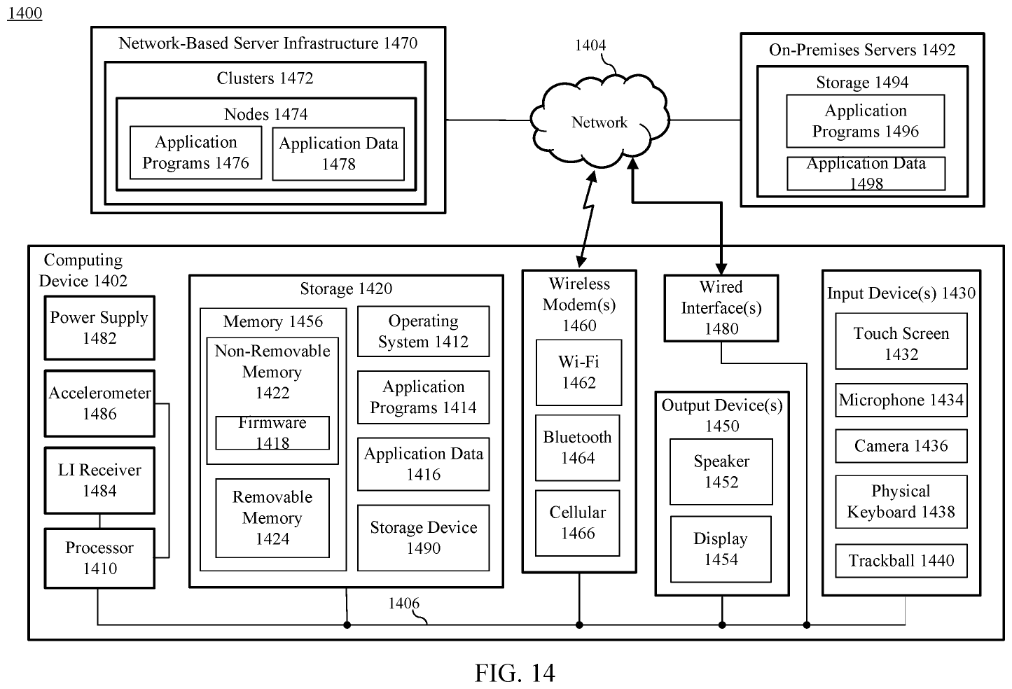

Referring to FIG. 13, flowchart 1300 begins with step 1302. In step 1302, a file extension for a file open in the first software application is identified. For example, prior to determining that the second software application is installed on the second computing environment, state manager 332 determines a file(s) extension for a file that was open in the first software application in first computing system 202.

In step 1304, a service API is called to determine an alternate application that can open a file having the identified file extension. For example, as described above, state manager 332 may call a service API that may access a store comprising a database(s) indicating which software applications are operable to open files with the identified file type. The service API may indicate to state manager 332 which alternate software applications are operable to open a file having the identified file extension.

In step 1306, it may be determined that the alternate second software application is not installed on the second computing environment. For example, state manager 332 may determine that none of the possible alternate software application(s) indicated by the API are installed in cloud-based PC 318. The service API may also indicate where to obtain the alternate software application(s).

In step 1308, the alternate second software application is downloaded and installed at the second computing environment. For example, state manager 332 may download and install an alternate second software application and proceed with state synchronization according to flow chart 1000 at step 1004 where it is now determined that the alternate application is installed in the second computing environment. In some aspects, prior to downloading the alternate second software application, state manager 332 may cause a message to be sent to a user via a user interface to ask the user if they would like to download the second alternate software application. If the user agrees, state manager 332 may download the second alternate software application and proceed with state synchronization as indicated above at step 1004 of flow chart 1000.

As described above, the state information of the first software application that executed in computing system 202 and is applied in the alternate second software application on cloud-based PC 318 for software application state synchronization, may comprise at least application agnostic state information relative to the first software application.

In some aspects, the first software application executing on computer system 202 is a browser and the at least a portion of the state information of the first software application applied in the alternate second application includes a uniform resource locator (URL) for synchronization of the alternate second software application.

As described above, in some instances, the state information of the first software application comprises at least a portion of memory state information of the first software application is applied in the second computing environment for synchronizing the alternate second software application.

Moreover, applying at least a portion of the state information of the first software application to an alternate application in the second computing environment comprises: at an operating system level on the second computing environment, swapping a pointer value set to a current memory location of a non-persistent memory of the memory system for executing the alternate second software application, to a value of a location in the non-persistent memory determined of the memory state information received from the first software application. For example, at an operating system level on the cloud-based PC 318, a pointer value that is set to a current memory location of cloud-based PC 381's non-persistent memory for executing the alternate second software application is changed to a pointer value pointing to a location in the non-persistent memory storing the memory state information from the first software application. In some aspects, the at least a portion of the state information of the first software application applied in the second computing environment (e.g., cloud-based PC 318) comprises window display properties for displaying window properties (or other application agnostic state information) at the second computing environment for synchronizing the state of the alternate second software application with the first software application. As describe above, the application agnostic information received in the synchronization file may include (1) mouse information such as dots per inch (DPI) aware x, y coordinates and other properties such as cursor color, icon properties, etc., (2) keyboard information such as DPI aware x, y coordinates and other keyboard properties such as cursor color, icon properties, blink rate, etc., (3) window properties such as DPI aware window x, y, coordinates, position, size (e.g., width and height), window focus, and/or z-order, and (3) state information such as current page, mouse and/or keyboard selection(s) that are agnostic to the first software application in use on the first computing system 202.

### III. Example Mobile Device and Computing Device Embodiments

Each of system 100, system 200, system 300, and system 900 and/or each of the steps of flowchart 400, flowchart 500, flowchart 600, flowchart 700, flowchart 800, flow diagram 900, flowchart 1000, flowchart 1100, flowchart 1200, and flowchart 1300 may be implemented in hardware, or hardware combined with software and/or firmware. For example, system 100, system 200, system 300, and system 900 (and/or any of the components thereof) and/or the steps of flowchart 400, flowchart 500, flowchart 600, flowchart 700, flowchart 800, flow diagram 900, flowchart 1000, flowchart 1100, flowchart 1200, and flowchart 1300 may be implemented as computer program code (e.g., instructions in a programming language) configured to be executed in one or more processors and stored in a computer readable storage medium. Alternatively, system 100, system 200, system 300, and system 900 (and/or any of the components thereof) and/or the steps of flowchart 400, flowchart 500, flowchart 600, flowchart 700, flowchart 800, flow diagram 900, flowchart 1000, flowchart 1100, flowchart 1200, and flowchart 1300 may be implemented as hardware logic/electrical circuitry, such as being implemented together in a system-on-chip (SoC), a field programmable gate array (FPGA), or an application specific integrated circuit (ASIC). A SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions. 1000

Embodiments disclosed herein may be implemented in one or more computing devices that may be mobile (a mobile device) and/or stationary (a stationary device) and may include any combination of the features of such mobile and stationary computing devices. Examples of computing devices in which embodiments may be implemented are described as follows with respect to FIG. 14. FIG. 14 shows a block diagram of exemplary computing environment(s) 1400 that includes a computing device 1402, a network-based server infrastructure 1470, and an on-premises servers 1492. As shown in FIG. 14, computing device 1402, network-based server infrastructure 1470, and on-premises storage 1492 are communicatively coupled via network 1404. Network 1404 comprises one or more networks such as local area networks (LANs), wide area networks (WANs), enterprise networks, the Internet, etc., and may include one or more wired and/or wireless portions. Network 1404 may additional or alternatively include a cellular network for cellular communications.

Embodiments described herein may be implemented in one or more of computing device 1402, network-based server infrastructure 1470, and on-premises servers 1492. For example, in some embodiments, computing device 1402 may be used to implement systems, clients, or devices, or components/subcomponents thereof, disclosed elsewhere herein. In other embodiments, a combination of computing device 1402, network-based server infrastructure 1470, and/or on-premises servers 1492 may be used to implement the systems, clients, or devices, or components/subcomponents thereof, disclosed elsewhere herein. Computing device 1402, network-based server infrastructure 1470, and on-premises storage 1492 are described in detail as follows.

Computing device 1402 can be any of a variety of types of computing devices. For example, computing device 1402 may be a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses, or other types of mobile computing devices. Computing device 1402 may alternatively be a stationary computing device such as a desktop computer, a personal computer (PC), a stationary server device, a minicomputer, a mainframe, a supercomputer, etc.

As shown in FIG. 14, computing device 1402 includes a variety of hardware and software components, including a processor 1410, a storage 1420, one or more input devices 1430, one or more output devices 1450, one or more wireless modems 1460, one or more wired interface(s) 1480, a power supply 1482, a location information (LI) receiver 1484, and an accelerometer 1486. Storage 1420 includes memory 1456, which includes non-removable memory 1422 and removable memory 1424, and a storage device 1490. Storage 1420 also stores an operating system 1412, application programs 1414, and application data 1416. Wireless modem(s) 1460 include a Wi-Fi modem 1462, a Bluetooth modem 1464, and a cellular modem 1466. Output device(s) 1450 includes a speaker 1452 and a display 1454. Input device(s) 1430 includes a touch screen 1432, a microphone 1434, a camera 1436, a physical keyboard 1438, and a trackball 1440. Not all components of computing device 1402 shown in FIG. 14 are present in all embodiments, additional components not shown may be present, and any combination of the components may be present in a particular embodiment. These components of computing device 1402 are described as follows.

A single processor 1410 (e.g., central processing unit (CPU), microcontroller, a microprocessor, signal processor, ASIC (application specific integrated circuit), and/or other physical hardware processor circuit) or multiple processors 1410 may be present in computing device 1402 for performing such tasks as program execution, signal coding, data processing, input/output processing, power control, and/or other functions. Processor 1410 may be a single-core or multi-core processor, and each processor core may be single-threaded or multithreaded (to provide multiple threads of execution concurrently). Processor 1410 is configured to execute program code stored in a computer readable medium, such as program code of operating system 1412 and application programs 1414 stored in storage 1420. Operating system 1412 controls the allocation and usage of the components of computing device 1402 and provides support for one or more application programs 1414 (also referred to as “applications” or “apps”). Application programs 1414 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein.

Any component in computing device 1402 can communicate with any other component according to function, although not all connections are shown for ease of illustration. For instance, as shown in FIG. 14, bus 1406 is a multiple signal line communication medium (e.g., conductive traces in silicon, metal traces along a motherboard, wires, etc.) that may be present to communicatively couple processor 1410 to various other components of computing device 1402, although in other embodiments, an alternative bus, further busses, and/or one or more individual signal lines may be present to communicatively couple components. Bus 1406 represents one or more of any of several types of bus structures, including a memory bus or memory controller, a peripheral bus, an accelerated graphics port, and a processor or local bus using any of a variety of bus architectures.

Storage 1420 is physical storage that includes one or both of memory 1456 and storage device 1490, which store operating system 1412, application programs 1414, and application data 1416 according to any distribution. Non-removable memory 1422 includes one or more of RAM (random access memory), ROM (read only memory), flash memory, a hard disk (e.g., a magnetic disk drive for reading from and writing to a hard disk), and/or other physical memory device type. Non-removable memory 1422 may include main memory and may be separate from or fabricated in a same integrated circuit as processor 1410. As shown in FIG. 14, non-removable memory 1422 stores firmware 1418, which may be present to provide low-level control of hardware. Examples of firmware 1418 include BIOS (Basic Input/Output System, such as on personal computers) and boot firmware (e.g., on smart phones). Removable memory 1424 may be inserted into a receptacle of or otherwise coupled to computing device 1402 and can be removed by a user from computing device 1402. Removable memory 1424 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 1490 may be present that are internal and/or external to a housing of computing device 1402 and may or may not be removable. Examples of storage device 1490 include a hard disk drive, a solid-state drive (SSD), a thumb drive (e.g., a USB (Universal Serial Bus) flash drive), or other physical storage device.

One or more programs may be stored in storage 1420. Such programs include operating system 1412, one or more application programs 1414, and other program modules and program data. Examples of such application programs may include, for example, computer program logic (e.g., computer program code/instructions) for implementing one or more of system 100, system 200, and system 30, along with any components and/or subcomponents thereof, as well as the flowcharts/flow diagrams (e.g., flowcharts 400, 500, and 600) described herein, including portions thereof, and/or further examples described herein.

Storage 1420 also stores data used and/or generated by operating system 1412 and application programs 1414 as application data 1416. Examples of application data 1416 include web pages, text, images, tables, sound files, video data, and other data, which may also be sent to and/or received from one or more network servers or other devices via one or more wired or wireless networks. Storage 1420 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 1402 through one or more input devices 1430 and may receive information from computing device 1402 through one or more output devices 1450. Input device(s) 1430 may include one or more of touch screen 1432, microphone 1434, camera 1436, physical keyboard 1438 and/or trackball 1440 and output device(s) 1450 may include one or more of speaker 1452 and display 1454. Each of input device(s) 1430 and output device(s) 1450 may be integral to computing device 1402 (e.g., built into a housing of computing device 1402) or external to computing device 1402 (e.g., communicatively coupled wired or wirelessly to computing device 1402 via wired interface(s) 1480 and/or wireless modem(s) 1460). Further input devices 1430 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 1454 may display information, as well as operating as touch screen 1432 by receiving user commands and/or other information (e.g., by touch, finger gestures, virtual keyboard, etc.) as a user interface. Any number of each type of input device(s) 1430 and output device(s) 1450 may be present, including multiple microphones 1434, multiple cameras 1436, multiple speakers 1452, and/or multiple displays 1454.

One or more wireless modems 1460 can be coupled to antenna(s) (not shown) of computing device 1402 and can support two-way communications between processor 1410 and devices external to computing device 1402 through network 1404, as would be understood to persons skilled in the relevant art(s). Wireless modem 1460 is shown generically and can include a cellular modem 1466 for communicating with one or more cellular networks, such as a GSM network for data and voice communications within a single cellular network, between cellular networks, or between the mobile device and a public switched telephone network (PSTN). Wireless modem 1460 may also or alternatively include other radio-based modem types, such as a Bluetooth modem 1464 (also referred to as a “Bluetooth device”) and/or Wi-Fi 1462 modem (also referred to as an “wireless adaptor”). Wi-Fi modem 1462 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 1464 is configured to communicate with another Bluetooth-capable device according to the Bluetooth short-range wireless technology standard(s) such as IEEE 802.15.1 and/or managed by the Bluetooth Special Interest Group (SIG).

Computing device 1402 can further include power supply 1482, LI receiver 1484, accelerometer 1486, and/or one or more wired interfaces 1480. Example wired interfaces 1480 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, an Ethernet port, and/or an Apple® Lightning® port, the purposes and functions of each of which are well known to persons skilled in the relevant art(s). Wired interface(s) 1480 of computing device 1402 provide for wired connections between computing device 1402 and network 1404, or between computing device 1402 and one or more devices/peripherals when such devices/peripherals are external to computing device 1402 (e.g., a pointing device, display 1454, speaker 1452, camera 1436, physical keyboard 1438, etc.). Power supply 1482 is configured to supply power to each of the components of computing device 1402 and may receive power from a battery internal to computing device 1402, and/or from a power cord plugged into a power port of computing device 1402 (e.g., a USB port, an A/C power port). LI receiver 1484 may be used for location determination of computing device 1402 and may include a satellite navigation receiver such as a Global Positioning System (GPS) receiver or may include other type of location determiner configured to determine location of computing device 1402 based on received information (e.g., using cell tower triangulation, etc.). Accelerometer 1486 may be present to determine an orientation of computing device 1402.

Note that the illustrated components of computing device 1402 are not required or all-inclusive, and fewer or greater numbers of components may be present as would be recognized by one skilled in the art. For example, computing device 1402 may also include one or more of a gyroscope, barometer, proximity sensor, ambient light sensor, digital compass, etc. Processor 1410 and memory 1456 may be co-located in a same semiconductor device package, such as being included together in an integrated circuit chip, FPGA, or system-on-chip (SOC), optionally along with further components of computing device 1402.

In embodiments, computing device 1402 is configured to implement any of the above-described features of flowcharts herein. Computer program logic for performing any of the operations, steps, and/or functions described herein may be stored in storage 1420 and executed by processor 1410.

In some embodiments, server infrastructure 1470 may be present. Server infrastructure 1470 may be a network-accessible server set (e.g., a cloud-based environment or platform). As shown in FIG. 14, server infrastructure 1470 includes clusters 1472. Each of clusters 1472 may comprise a group of one or more compute nodes and/or a group of one or more storage nodes. For example, as shown in FIG. 14, cluster 1472 includes nodes 1474. Each of nodes 1474 are accessible via network 1404 (e.g., in a cloud-based embodiment) to build, deploy, and manage applications and services. Any of nodes 1474 may be a storage node that comprises a plurality of physical storage disks, SSDs, and/or other physical storage devices that are accessible via network 1404 and are configured to store data associated with the applications and services managed by nodes 1474. For example, as shown in FIG. 14, nodes 1474 may store application data 1478.

Each of nodes 1474 may, as a compute node, comprise one or more server computers, server systems, and/or computing devices. For instance, a node 1474 may include one or more of the components of computing device 1402 disclosed herein. Each of nodes 1474 may be configured to execute one or more software applications (or “applications”) and/or services and/or manage hardware resources (e.g., processors, memory, etc.), which may be utilized by users (e.g., customers) of the network-accessible server set. For example, as shown in FIG. 14, nodes 1474 may operate application programs 1476. In an implementation, a node of nodes 1474 may operate or comprise one or more virtual machines, with each virtual machine emulating a system architecture (e.g., an operating system), in an isolated manner, upon which applications such as application programs 1476 may be executed.

In an embodiment, one or more of clusters 1472 may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 1472 may be a datacenter in a distributed collection of datacenters. In embodiments, exemplary computing environment(s) 1400 comprises part of a cloud-based platform such as Amazon Web Services® of Amazon Web Services, Inc. or Google Cloud Platform™ of Google LLC, although these are only examples and are not intended to be limiting.

In an embodiment, computing device 1402 may access application programs 1476 for execution in any manner, such as by a client application and/or a browser at computing device 1402. Example browsers include Microsoft Edge® by Microsoft Corp. of Redmond, Washington, Mozilla Firefox®, by Mozilla Corp. of Mountain View, California, Safari®, by Apple Inc. of Cupertino, California, and Google® Chrome by Google LLC of Mountain View, California.

For purposes of network (e.g., cloud) backup and data security, computing device 1402 may additionally and/or alternatively synchronize copies of application programs 1414 and/or application data 1416 to be stored at network-based server infrastructure 1470 as application programs 1476 and/or application data 1478. For instance, operating system 1412 and/or application programs 1414 may include a file hosting service client, such as Microsoft® OneDrive® by Microsoft Corporation, Amazon Simple Storage Service (Amazon S3)® by Amazon Web Services, Inc., Dropbox® by Dropbox, Inc., Google Drive™ by Google LLC, etc., configured to synchronize applications and/or data stored in storage 1420 at network-based server infrastructure 1470.

In some embodiments, on-premises servers 1492 may be present. On-premises servers 1492 are hosted within an organization's infrastructure and, in many cases, physically onsite of a facility of that organization. On-premises servers 1492 are controlled, administered, and maintained by IT (Information Technology) personnel of the organization or an IT partner to the organization. Application data 1498 may be shared by on-premises servers 1492 between computing devices of the organization, including computing device 1402 (when part of an organization) through a local network of the organization, and/or through further networks accessible to the organization (including the Internet). Furthermore, on-premises servers 1492 may serve applications such as application programs 1496 to the computing devices of the organization, including computing device 1402. Accordingly, on-premises servers 1492 may include storage 1494 (which includes one or more physical storage devices such as storage disks and/or SSDs) for storage of application programs 1496 and application data 1498 and may include one or more processors for execution of application programs 1496. Still further, computing device 1402 may be configured to synchronize copies of application programs 1414 and/or application data 1416 for backup storage at on-premises servers 1492 as application programs 1496 and/or application data 1498.

As used herein, the terms “computer program medium,” “computer-readable medium,” and “computer-readable storage medium,” etc., are used to refer to physical hardware media. Examples of such physical hardware media include any hard disk, magnetic disk, optical disk, other physical hardware media such as RAMs, ROMs, flash memory, digital video disks, zip disks, MEMs (microelectronic machine) memory, nanotechnology-based storage devices, and further types of physical/tangible hardware storage media of storage 1420. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 1414) may be stored in storage 1420. Such computer programs may also be received via wired interface(s) 1480 and/or wireless modem(s) 1460 over network 1404. Such computer programs, when executed or loaded by an application, enable computing device 1402 to implement features of embodiments discussed herein. Accordingly, such computer programs represent controllers of the computing device 1402.

Embodiments are also directed to computer program products comprising computer code or instructions stored on any computer-readable medium or computer-readable storage medium. Such computer program products include the physical storage of storage 1420 as well as further physical storage types.

### IV. Additional Examples and Advantages

In an embodiment, a system for synchronizing a state of a first instance of a software application executing on a first computing environment with a second instance of the software application to be executed on a second computing environment comprises the first computing environment. The first computing environment comprises a memory system comprising a runtime memory and a persistent memory that stores program code and a processing system comprising at a processor that receives the program code from the memory system. In response to at least receiving the program code, the processor locks the first instance of the software application preventing user inputs thereto and generation of a new instance thereof, scans at least one of the runtime memory or the persistent memory to identify memory state information that is specific to the first instance of the software application and writes the memory state information to a data structure in a synchronization file stored in the memory system. The processor further intercepts render commands for the first instance of the software application via an operating system level system filter to identify execution state information that is specific to the first instance of the software application, writes the execution state information to the data structure, and transmits the synchronization file to the second computing environment.

In an embodiment of the foregoing system, the processing system displays a screen indicating that the state synchronization of the software application is in progress in conjunction with locking the first instance of the software application.

In an embodiment of the foregoing system, further in response to said at least receiving the program code, the processing system locates data files specific to the first instance of the software application in the persistent memory. The located data files store at least one of version information of the first instance of the software application, installation information, configuration information, dependent component information, user identity information, or access token information. In response to determining that a first data file of the located data files does not match a corresponding second data file on the second computing environment, the processing system copies a difference of information between the first data file and the second data file, and transmits the difference of information to the second computing environment for state synchronization, or in response to determining that information from the located data files cannot be transmitted to the second computing environment, the processing system (1) auto-remediates by determining an available port in the second computing environment, switching to a same port on the first computing environment, and transmitting the difference of information to the second computing environment via the available port for state synchronization, (2) causes manual-remediation by sending a message to a user with instructions for opening a particular port in the second computing environment, and transmitting the difference of information to the second computing environment via the particular port for state synchronization, or (3) halts the state synchronization of the first instance of the software application.

In an embodiment of the foregoing system, further in response to said at least receiving the program code, the processing system in response to determining that a file open in the first instance of the software application in the first computing environment is not synchronized in the second computing environment, transmits the file to the second computing environment for synchronization.

In an embodiment of the foregoing system, further in response to said at least receiving the program code, the processing system (1) determines a lack of ability to synchronize at least a portion of a network configuration for the first instance of the software application stored in the run-time memory of the first computing environment to the second computing environment, where the network configuration comprises at least one of access to a uniform resource locator (URL) or availability of a network port, and (2) auto-remediates the lack of ability to synchronize the at least a portion of the network configuration to the second computing environment, provides steps for performing manual remediation of the lack of ability to synchronize the at least a portion of the network configuration to the second computing environment via a user interface, or stops the state synchronization of the software application.

In an embodiment of the foregoing system, the processing system scans at least one of the runtime memory or the persistent memory to identify memory state information that is specific to the software application, and writes the memory state information to a data structure in a synchronization file stored in the memory system by identifying a first portion of the memory state information that is stored in a hot state in the runtime memory and a second portion of the memory state information that is stored in a cold state paged to the persistent memory, and capturing the memory state information for said write the memory state information by (1) capturing the first portion of the memory state information and capturing the second portion of the memory state information, and writing the captured first portion of the memory state information and the captured second portion of the memory state information to the data structure in the synchronization file according to a hot state format and a cold state format respectively, (2) capturing the first portion of the memory state information and paging the first portion of the memory state information to the persistent memory according to the cold state format, capturing the first portion of the memory state information and the second portion of the memory state information from the persistent memory, and writing the captured first portion of the memory state information and the captured second portion of memory state information to the data structure in the synchronization file according to the cold state format, or (3) un-paging the second portion of the memory state information stored in the cold state in persistent memory and storing the second portion of the memory state information in runtime memory according to the hot state format, capturing the first portion of the memory state information and the second portion of the memory state information from the runtime memory, and writing the captured first portion of the memory state information and the captured second portion of memory state information to the data structure in the synchronization file according to the hot state format.

In an embodiment of the foregoing system, the identified execution state information that is specific to the first instance of the software application comprises one or more of active window or sub window handles, open menus, tabs, toolbars, or ribbons, a current page, a current web page, characteristics of mouse selection, characteristics of keyboard selection, or characteristics of pen input.

In an embodiment of the foregoing system, the processing system writes a last sequence of chained render commands to the data structure for said transmitting the synchronization file to the second computing environment, and does not write a first render command and a second render command to the data structure in instances where the second render command cancels an operation performed based on the first render command.

In an embodiment of the foregoing system, the processing system captures application agnostic state information and writes the application agnostic state information to the data structure.

In an embodiment of the foregoing system, the application agnostic state information comprises at least one of mouse cursor properties, keyboard cursor properties, window display properties, or opened uniform resource locators (URL).

In an embodiment of the foregoing system, further in response to said at least receiving the program code, the processing system performs steps for writing at least one of memory state information, execution state information, or agnostic state information to the data structure in the synchronization file for any other software applications the software application depends on.

In an embodiment of the foregoing system, the first computing environment comprises a local computing device, a virtual cloud computing machine, or a container, and the second computing environment comprises a local computing device, a virtual cloud computing machine, or a container.

In an embodiment, a method for synchronizing a state of a first instance of a software application executing on a first computing environment with a second instance of the software application to be executed on a second computing environment comprises locking the first instance of the software application executing in the first computing environment preventing user inputs thereto and generation of a new instance thereof. Render commands are intercepted for the first instance of the software application via an operating system level system filter to identify execution state information that is specific to the first instance of the software application. The execution state information is written to the data structure and the synchronization file is transmitted to the second computing environment.

In an embodiment of the foregoing method, at least one of the runtime memory or the persistent memory is scanned to identify memory state information that is specific to the first instance of the software application. The memory state information is written to the data structure in the synchronization file stored in the memory system for said transmits the synchronization file to the second computing environment.

In an embodiment, a system for synchronizing a state of a first instance of a software application executing on a first computing environment with a second instance of the software application to be executed on a second computing environment comprises the second computing environment. The second computing environment comprises a memory system, comprising a runtime memory and a persistent memory, that stores program code, and a processing system comprising at a processor that receives the program code from the memory system. In response to at least receiving the program code, the processing system receives a synchronization file of the first instance of the software application. The synchronization file includes a data structure having memory state information and execution state information therein that is specific to the first instance of the software application executing on the first computing environment. The memory state information is written to at least one of the runtime memory or the persistent memory at a respective location having a respective first memory pointer pointing thereto. Execution of the second instance of the software application is initiated on the second computing environment. At an operating system level, a second memory pointer associated with the second instance of the software application is updated to the respective first memory pointer. The update is performed subsequent to said initiate execution of the second instance of the software application. The second instance of the software application is synchronized to the execution state information including altering at least one user interface element associated with the second instance of the software application.

In an embodiment of the foregoing method, state information specific to the first instance of the software application is synchronized in the second computing environment relative to the first computing environment. The synchronized state information includes at least one of version information of the first instance of the software application, installation information, configuration information, dependent component information, user identity information, or access token information stored in the persistent memory, files to be opened in the second instance of the software application, and a network configuration for the second instance of the software application stored in the run-time memory of the second computing environment.

In an embodiment of the foregoing method, the processing system synchronizes the second instance of the software application to the execution state information including altering at least one user interface element associated with the second instance of the software application by executing, in the second computing environment, render commands that are based on the execution state information. The at least one user interface element associated with the second instance of the software application comprises at least one of: active window or sub window handles, open menus, tabs, toolbars, or ribbons, a current page, a current web page, characteristics of mouse selection, characteristics of keyboard selection, or characteristics of pen input.

In an embodiment of the foregoing method, the data structure further includes agnostic state information therein that is agnostic relative to the first instance of the software application, and the processing system synchronizes the second instance of the software application in the second computing environment to the agnostic state information.

In an embodiment of the foregoing method, the agnostic state information comprises at least one of: mouse cursor properties, keyboard cursor properties, window display properties, or uniform resource locators (URL).

In an embodiment of the foregoing method, the processing system synchronizes the second instance of the software application in the second computing environment to the agnostic state information by applying window display properties of the agnostic state information in the second computing environment including at least one of window position, size, focus, z-order, dots-per-inch aware window x, y coordinates, width, or height.

### V. Further Example Embodiments

As described, systems and devices embodying the techniques herein are configured and enabled in various ways to perform their respective functions for application state synchronization across computing environments. In embodiments, one or more of the steps or operations of any flowchart and/or flow diagram described herein are not performed, in embodiments. Moreover, steps or operations in addition to or in lieu of those in any flowchart and/or flow diagram described herein are performed, in embodiments. Further, in examples, one or more operations of any flowchart and/or flow diagram described herein are performed out of order, in an alternate sequence, or partially (or completely) concurrently with each other or with other operations, in embodiments.

As described herein, systems, devices, components, etc., of the embodiments that are configured to perform functions and/or operations are also contemplated as performing such functions and/or operations.

Prior solutions for synchronizing files, applications, and user profiles, and for virtual machine migration, fail to adequately address issues with sizes of data and times for transfers and do not provide the ability to synchronize the states of applications across multiple computing devices. Virtual machine migrations require porting the entire virtual machine from one environment to another, and thus large amounts of data are transmitted taxing system bandwidth and memory footprint while also taking excessive times for completion. Additionally, regarding the synchronizing files, applications, and user profiles, no prior solutions provide the ability to execute an application at a target device to open a particular file and recreate the application state from the source device as it was presented to a user at the time of transfer and synchronization. In contrast, the aspects herein utilize application-specific memory scans and OS-level filters for render commands to transfer and synchronization application states across computing environments, enabling a transferred, synchronized application to be rendered at the target computing environment exactly, or almost exactly, as it did when executed at the source computing environment. Such aspects were previously not available for software solutions, much less for the specific embodiments described herein for various source/target configurations across different platforms, operating systems, computing environments, and associated computing devices.

The additional examples and embodiments described in this Section are applicable to examples disclosed in any other Section or subsection of this disclosure.

Embodiments in this description provide methods, systems, apparatuses, and computer-readable storage mediums that are configured for application state synchronization across computing environments.

### VI. Explanatory Notes

The present specification and accompanying drawings disclose numerous example implementations. The scope of the present application is not limited to the disclosed implementations, but also encompasses combinations of the disclosed implementations, as well as modifications to the disclosed implementations. References in the specification to “one implementation,” “an implementation,” “an example embodiment,” “example implementation,” or the like, indicate that the implementation described includes a particular feature, structure, or characteristic, but every implementation does not necessarily include the particular feature, structure, or characteristic. Moreover, such phrases are not necessarily referring to the same implementation. Further, when a particular feature, structure, or characteristic is described in connection with an implementation, it is submitted that it is within the knowledge of persons skilled in the relevant art(s) to implement such feature, structure, or characteristic in connection with other implementations whether or not explicitly described.

In the discussion, unless otherwise stated, adjectives such as “substantially” and “about” modifying a condition or relationship characteristic of a feature or features of an implementation of the disclosure, should be understood to mean that the condition or characteristic is defined to within tolerances that are acceptable for operation of the implementation for an application for which it is intended.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

If the performance of an operation is described herein as being “based on” one or more factors, it is to be understood that the performance of the operation is based solely on such factor(s) or is based on such factor(s) along with one or more additional factors, in aspects. Thus, as used herein, the term “based on” should be understood to be equivalent to the term “based at least on.”

Numerous example embodiments are described as follows. It is noted that any section/subsection headings provided herein are not intended to be limiting. Implementations are described throughout this document, and any type of implementation is includable under any section/subsection. Furthermore, implementations disclosed in any section/subsection are combinable with any other implementations described in the same section/subsection and/or a different section/subsection in any manner.

### VII. Conclusion

While various example embodiments have been described above, it should be understood that they have been presented by way of example only, and not limitation. It will be understood by those skilled in the relevant art(s) that various changes in form and details are made therein for embodiments without departing from the spirit and scope of the embodiments as defined in the appended claims. Accordingly, the breadth and scope of the disclosure should not be limited by any of the above-described example embodiments, but should be defined only in accordance with the following claims and their equivalents.

What is claimed is:

1. A system for synchronizing a state of a first instance of a software application executing on a first computing environment with a second instance of the software application to be executed on a second computing environment, the system comprising:
the first computing environment, comprising:
a memory system, comprising a runtime memory and a persistent memory, that stores program code; and
a processing system, comprising a processor, that receives the program code from the memory system and, in response to at least receiving the program code:
locks the first instance of the software application preventing user inputs thereto and generation of a new instance thereof;
scans at least one of the runtime memory or the persistent memory to identify memory state information that is specific to the first instance of the software application;
writes the memory state information to a data structure in a synchronization file stored in the memory system;
intercepts render commands for the first instance of the software application via an operating system level system filter to identify execution state information that is specific to the first instance of the software application;
writes the execution state information to the data structure; and
transmits the synchronization file to the second computing environment.

2. The system of claim 1, wherein the processing system displays a screen indicating that the state synchronization of the software application is in progress in conjunction with locking the first instance of the software application.

3. The system of claim 1, wherein further in response to said at least receiving the program code, the processing system:
locates data files specific to the first instance of the software application in the persistent memory, wherein the located data files store at least one of version information of the first instance of the software application, installation information, configuration information, dependent component information, user identity information, or access token information;
and:
in response to determining that a first data file of the located data files does not match a corresponding second data file on the second computing environment, copies a difference of information between the first data file and the second data file; and
transmits the difference of information to the second computing environment for state synchronization; or
in response to determining that information from the located data files cannot be transmitted to the second computing environment:
auto-remediates by determining an available port in the second computing environment, switching to a same port on the first computing environment, and transmitting the difference of information to the second computing environment via the available port for state synchronization;
causes manual-remediation by sending a message to a user with instructions for opening a particular port in the second computing environment, and transmitting the difference of information to the second computing environment via the particular port for state synchronization; or
halts the state synchronization of the first instance of the software application.

4. The system of claim 1, wherein further in response to said at least receiving the program code, the processing system:
in response to determining that a file open in the first instance of the software application in the first computing environment is not synchronized in the second computing environment, transmitting the file to the second computing environment for synchronization.

5. The system of claim 1, wherein further in response to said at least receiving the program code, the processing system:
determines a lack of ability to synchronize at least a portion of a network configuration for the first instance of the software application stored in the run-time memory of the first computing environment to the second computing environment, wherein the network configuration comprises at least one of access to a uniform resource locator (URL) or availability of a network port;
and:
auto-remediates the lack of ability to synchronize the at least a portion of the network configuration to the second computing environment;
provides steps for performing manual remediation of the lack of ability to synchronize the at least a portion of the network configuration to the second computing environment via a user interface; or
stops the state synchronization of the software application.

6. The system of claim 1, wherein the processing system scans at least one of the runtime memory or the persistent memory to identify memory state information that is specific to the software application, and writes the memory state information to a data structure in a synchronization file stored in the memory system by:
identifying a first portion of the memory state information that is stored in a hot state in the runtime memory and a second portion of the memory state information that is stored in a cold state paged to the persistent memory; and
capturing the memory state information for said write the memory state information by:
capturing the first portion of the memory state information and capturing the second portion of the memory state information, and writing the captured first portion of the memory state information and the captured second portion of the memory state information to the data structure in the synchronization file according to a hot state format and a cold state format respectively;
capturing the first portion of the memory state information and paging the first portion of the memory state information to the persistent memory according to the cold state format, capturing the first portion of the memory state information and the second portion of the memory state information from the persistent memory, and writing the captured first portion of the memory state information and the captured second portion of memory state information to the data structure in the synchronization file according to the cold state format; or
un-paging the second portion of the memory state information stored in the cold state in persistent memory and storing the second portion of the memory state information in runtime memory according to the hot state format, capturing the first portion of the memory state information and the second portion of the memory state information from the runtime memory, and writing the captured first portion of the memory state information and the captured second portion of memory state information to the data structure in the synchronization file according to the hot state format.

7. The system of claim 1, wherein the identified execution state information that is specific to the first instance of the software application comprises one or more of:
active window or sub window handles;
open menus, tabs, toolbars, or ribbons;
a current page;
a current web page;
characteristics of mouse selection;
characteristics of keyboard selection; or
characteristics of pen input.

8. The system of claim 1, wherein the processing system writes a last sequence of chained render commands to the data structure for said transmitting the synchronization file to the second computing environment and does not write a first render command and a second render command to the data structure in instances where the second render command cancels an operation performed based on the first render command.

9. The system of claim 1, wherein the processing system captures application agnostic state information and writes the application agnostic state information to the data structure.

10. The system of claim 9, wherein the application agnostic state information comprises at least one of:
mouse cursor properties;
keyboard cursor properties;
window display properties; or
opened uniform resource locators (URL).

11. The system of claim 1, wherein further in response to said at least receiving the program code, the processing system performs steps for writing at least one of memory state information, execution state information, or agnostic state information to the data structure in the synchronization file for any other software applications the software application depends on.

12. The system of claim 1, wherein the first computing environment comprises a local computing device, a virtual cloud computing machine, or a container, and the second computing environment comprises a local computing device, a virtual cloud computing machine, or a container.

13. A method for synchronizing a state of a first instance of a software application executing on a first computing environment with a second instance of the software application to be executed on a second computing environment, the method comprising:
locking the first instance of the software application executing in the first computing environment preventing user inputs thereto and generation of a new instance thereof;
intercepting render commands for the first instance of the software application via an operating system level system filter to identify execution state information that is specific to the first instance of the software application;
writing the execution state information to the data structure; and
transmitting the synchronization file to the second computing environment.

14. The method of claim 13, further comprising:
scanning at least one of the runtime memory or the persistent memory to identify memory state information that is specific to the first instance of the software application; and
writing the memory state information to the data structure in the synchronization file stored in the memory system for said transmits the synchronization file to the second computing environment.

15. A system for synchronizing a state of a first instance of a software application executing on a first computing environment with a second instance of the software application to be executed on a second computing environment, the system comprising:
the second computing environment comprising:
a memory system, comprising a runtime memory and a persistent memory, that stores program code; and
a processing system, comprising a processor, that receives the program code from the memory system and, in response to at least receiving the program code:
receives a synchronization file of the first instance of the software application, the synchronization file including a data structure having memory state information and execution state information therein that is specific to the first instance of the software application executing on the first computing environment;
write the memory state information to at least one of the runtime memory or the persistent memory at a respective location having a respective first memory pointer pointing thereto;
initiate execution of the second instance of the software application on the second computing environment;
update, at an operating system level, a second memory pointer associated with the second instance of the software application to the respective first memory pointer, said update performed subsequent to said initiate execution of the second instance of the software application; and
synchronize the second instance of the software application to the execution state information including altering at least one user interface element associated with the second instance of the software application.

16. The system of claim 15, wherein state information specific to the first instance of the software application is synchronized in the second computing environment relative to the first computing environment, and wherein the synchronized state information includes at least one of version information of the first instance of the software application, installation information, configuration information, dependent component information, user identity information, or access token information stored in the persistent memory, files to be opened in the second instance of the software application, and a network configuration for the second instance of the software application stored in the run-time memory of the second computing environment.

17. The system of claim 15, wherein the processing system synchronizes the second instance of the software application to the execution state information including altering at least one user interface element associated with the second instance of the software application by executing, in the second computing environment, render commands that are based on the execution state information, wherein the at least one user interface element associated with the second instance of the software application comprises at least one of:
active window or sub window handles;
open menus, tabs, toolbars, or ribbons;
a current page;
a current web page;
characteristics of mouse selection;
characteristics of keyboard selection; or
characteristics of pen input.

18. The system of claim 15, wherein the data structure further includes agnostic state information therein that is agnostic relative to the first instance of the software application, and the processing system synchronizes the second instance of the software application in the second computing environment to the agnostic state information.

19. The system of claim 18, wherein the agnostic state information comprises at least one of:
mouse cursor properties;
keyboard cursor properties;
window display properties; or
uniform resource locators (URL).

20. The system of claim 18, wherein the processing system synchronizes the second instance of the software application in the second computing environment to the agnostic state information by applying window display properties of the agnostic state information in the second computing environment including at least one of window position, size, focus, z-order, dots-per-inch aware window x, y coordinates, width, or height.
